(19) United States
(12) Patent Application Publication
(10) Pub. No.: US 2025/0110600 A1
(43) Pub. Date: Apr. 3, 2025

(54) BUILDING MANAGEMENT SYSTEM WITH ZERO CLICK DATA CENTER HEATMAP

(71) Applicant: Tyco Fire & Security GmbH, Neuhausen am Rheinfall (CH)

(72) Inventors: Gerald A. Asp, Milwaukee, WI (US); Joshua Karl Sievert, Milwaukee, WI (US); Collin Eggert, Milwaukee, WI (US); Nicholas Schaf, Hartland, WI (US); Teresa J. Hutton, New Berlin, WI (US); Matthew T. Trawicki, Franklin, WI (US)

(21) Appl. No.: 18/641,658

(22) Filed: Apr. 22, 2024

Related U.S. Application Data
(60) Provisional application No. 63/541,653, filed on Sep. 29, 2023.

(51) Int. Cl. G06F 3/0481; G06F 3/04842; G06F 12/0802; H04L 67/12

(52) U.S. Cl. CPC G06F 3/0481; G06F 12/0802; G06F 3/04842; G06F 2212/60; H04L 67/12

(57) ABSTRACT

A Building Management System (BMS) can include one or more memory devices that can store instructions thereon. The instructions, when executed by one or more processors, can cause the one or more processors to receive a first set of data corresponding to a plurality of parameters of one or more aspects of a building, generate a user interface including one or more graphical representations of one or more first values, receive a dataset corresponding to a Change of Value (COV) for at least one value of the one or more first values, and update at least one graphical representation of the one or more graphical representations to reflect the COV for the at one value of the one or more first values.

### CROSS-REFERENCE TO RELATED PATENT APPLICATIONS

This application claims the benefit of and priority to U.S. Provisional Patent Application No. 63/541,653, filed Sep. 29, 2023. The entirety of which is incorporated by reference herein.

### TECHNICAL FIELD

The present disclosure relates generally to building management systems or building automation systems.

### BACKGROUND

A Building Management System (BMS) or Building Automation System (BAS) is, in general, a system of devices configured to control, monitor, and/or manage equipment in or around a building or building area. A BMS or BAS can include, for example, a HVAC system, a security system, a lighting system, a fire alerting system, any other system that is capable of managing building functions or devices, or any combination thereof. The terms BMS and BAS are used synonymously throughout the present disclosure.

A BAS may be controllable from a localized and/or an onsite premise. For example, a BAS may be controllable by an admin within a building. The admin may control the BAS using a computing device (e.g., a desktop computer).

Many BAS or BMS systems contain separate subsystems to store value data, authorization data, and semantic data. Additionally, many of these systems transmit all stored data to the BMS on request. Transmitting data from separate subsystems, each of which contain large quantities of data, may result in unnecessary time delays. It would be desirable to aggregate measured and transmitted data in a manner that may be quickly transmitted and easily accessible across building systems.

### SUMMARY

At least one embodiment relates to a Building Management System (BMS). The BMS can include one or more memory devices. The one or more memory devices can store instructions thereon. The instructions can, when executed by one or more processors, cause the one or more processors to receive a first set of data corresponding to a plurality of parameters of a first piece of building equipment of a plurality of pieces of building equipment for a building. The instructions can also cause the one or more processors to extract, from the first set of data, one or more first values associated with the plurality of parameters of the first piece of building equipment. The instructions can also cause the one or more processors to detect, based on a comparison between the first set of data and a previous set of data pertaining to the first piece of building equipment, a difference between the one or more first values with respect to one or more second values included in the previous set of data. The difference can indicate a Change of Value (COV) for at least one parameter of the plurality of parameters. The instructions can also cause the one or more processors to transmit, responsive to detection of the difference, a second set of data to identify the COV.

In some embodiments, the instructions can also cause the one or more processors to retrieve, from a database, the previous set of data responsive to extraction of the one or more first values. The instructions can also cause the one or more processors to update, responsive to indication of the COV, the previous set of data to reflect the COV.

In some embodiments, the instructions can also cause the one or more processors to receive a third set of data corresponding to a second plurality of parameters of a second piece of building equipment of the plurality of pieces of building equipment. The instructions can also cause the one or more processors to detect, based on a comparison between the third set of data and a second previous set of data pertaining to the second piece of building equipment, a second difference between one or more third values included in the third set of data with respect to one or more fourth values included in the second previous set of data pertaining to the second piece of building equipment. The instructions can also cause the one or more processors to determine, responsive to detection of the second difference, that that second difference is within a predetermined threshold. The instructions can also cause the one or more processors to prevent, based on the second difference being within the predetermined threshold, transmission of a fourth set of data.

In some embodiments, the first set of data can be received in a first format. The instructions can also cause the one or more processors to translate, based on one or more translations stored in a database, the first set of data from the first format to a second format. The instructions can also cause the one or more processors to transmit, responsive to translation of the first set of data, the first set of data to a cloud system. The first set of data having the first can be unrecognizable by the cloud system, and the first set of data having the second format can be recognizable by the cloud system.

In some embodiments, the plurality of pieces of building equipment can be controllable with one or more control signals having the first format, and wherein the plurality of pieces of building equipment produce information having the first format.

In some embodiments, the instructions can also cause the one or more processors to transmit the second set of data to a cloud system, and the second set of data can be transmitted without a prompt from the cloud system.

In some embodiments, the second set of data can be transmitted to a cloud system. The instructions can also cause the one or more processors to provide, to the cloud system, a prompt to provide a credential to verify the cloud system. The instructions can also cause the one or more processors to receive, from the cloud system, the credential. The instructions can also cause the one or more processors to verify, responsive to confirmation of a match between the credential and a value stored in a database, the cloud system. The instructions can also cause the one or more processors to transmit, responsive to verification of the cloud system, the second set of data to the cloud system.

In some embodiments, the instructions can also cause the one or more processors to transmit the second set of data to identify the COV responsive to a determination that the difference between the one or more first values with respect to the one or more second values exceeds a predetermined threshold.

At least one embodiment relates to a Building Management System (BMS). The BMS can include one or more memory devices. The one or more memory device can store instructions thereon. The instructions can, when executed by one or more processors, cause the one or more processors to receive a first set of data corresponding to a plurality of parameters of one or more aspects of a building. The first set of data can include one or more first values. The instructions can also cause the one or more processors to generate, responsive to receipt of the first set of data, a user interface including one or more graphical representations of the one or more first values. The one or more graphical representations can include selectable elements. The instructions can also cause the one or more processors to receive, from a computing device in communication with one or more pieces of building equipment of the building, a dataset corresponding to a Change of Value (COV) for at least one value of the one or more first values. The instructions can also cause the one or more processors to update, responsive to receipt of the dataset, at least one graphical representation of the one or more graphical representations to reflect the COV for the at one value of the one or first more values.

In some embodiments, the one or more first values can correspond to information maintained in a first cache stored in memory of the computing device. The computing device can update the information maintained in the first cache based on a detection of one or more COVs. The instructions can cause the one or more processors to maintain, in a second cache stored in the one or more memory devices, a plurality of values corresponding to the plurality of parameters. The plurality of values can be provided by the computing device. The instructions can also cause the one or more processors to update, responsive to receipt of the first set of data, the second cache to reflect the one or more first values. The instructions can also cause the one or more processors to update the second cache to reflect the COV for the at least one value of the one or more first values.

In some embodiments, the instructions can also cause the one or more processors to receive, responsive to updating the at least one graphical representation of the one or more graphical representations, an indication of a selection of at least one selectable element of the selectable elements. The at least one selectable element can be associated with a given aspect of the one or more aspects of the building. The instructions can also cause the one or more processors to update, responsive to receipt of the indication, the user interface to include information associated with the given aspect of the one or more aspects of the building.

In some embodiments, the one or more graphical representations of the one or more aspects of the building can include a heatmap of the building.

In some embodiments, the computing device can determine the COV based on a difference between the one or more first values and one or more second values stored in a cache of the computing device. The computing device can communicate one or more subsequent COVs.

In some embodiments, the instructions can also cause the one or more processors to receive, from a user device, an indication of a predetermined range to define a difference between the one or more first values and one or more second values. The instructions can also cause the one or more processors to provide, via a connection with the computing device, the indication of the predetermined range to cause the computing device to detect subsequent COVs based on given values that exceed the predetermined range.

In various embodiments, the first set of data can include a first size. The dataset can include a second size. The second size can be less than the first size.

In some embodiments, the first set of data can include a first number of bits. The dataset can include a second number of bits. The second number of bits can be less than the first number of bits.

In some embodiments, the computing device can be an edge device located at the building. At least a portion of the BMS can be stored via a server bank remote to the building.

At least one embodiment relates to a method. The method can include receiving, by one or more processing circuits, a first set of data corresponding to a plurality of parameters of one or more aspects of a building. The first set of data can include one or more first values. The method can also include generating, by the one or more processing circuits, responsive to receipt of the first set of data, a user interface including one or more graphical representations of the one or more first values. The one or more graphical representations can include selectable elements.

The method can also include receiving, by the one or more processing circuits from a computing device in communication with one or more pieces of building equipment of the building, a dataset corresponding to a Change of Value (COV) for at least one value of the one or more first values. The method can also include updating, by the one or more processing circuits responsive to receipt of the dataset, at least one graphical representation of the one or more graphical representations to reflect the COV for the at least one value of the one or more first values.

In some embodiments, the one or more first values can correspond to information maintained in a first cache stored in memory of the computing device. The computing device can be is configured to update the information maintained in the first cache based on a detection of one or more COVs. The method can include maintaining, by the one or more processing circuits in a second cache stored in one or more memory devices, a plurality of values corresponding to the plurality of parameters. The plurality of values can be provided by the computing device. The method can also include updating, by the one or more processing circuits responsive to receipt of the first set of data, the second cache to reflect the one or more first values. The method can also include updating, by the one or more processing circuits, responsive to receipt of the dataset, the second cache to reflect the COV for the at least one value of the one or more first values.

In some embodiments, the method can also include receiving, by the one or more processing circuits responsive to updating the at least one graphical representation of the one or more graphical representations, an indication of a selection of at least one selectable element of the selectable elements. The selectable elements can be associated with a given aspect of the one or more aspects of the building. The method can also include updating, by the one or more processing circuits responsive to receipt of the indication, the user interface to include information associated with the given aspect of the one or more aspects of the building.

In some embodiments, the one or more graphical representations of the one or more aspects of the building can include a heatmap of the building.

In some embodiments, the computing device can determine the COV based on a difference between the one or more first values and one or more second values stored in a cache of the computing device. The computing device can communicate one or more subsequent COVs.

In some embodiments, the method can include receiving, by the one or more processing circuits from a user device, an indication of a predetermined range to define a difference between the one or more first values and one or more second values. Detection of a given value that exceeds the predetermined range can cause the computing device to detect a subsequent COV.

In some embodiments, the first set of data can include a first size. The dataset can include a second size. The second size can be less than the first size.

In some embodiments, the first set of data can include a first number of bits. The dataset can include a second number of bits. The second number of bits can be less than the first number of bits.

In some embodiments, the computing device can be an edge device located at the building. The one or more processing circuits can be stored in a server bank remote to the building.

At least one embodiment relates to a BMS system. The BMS system can include one or more memory devices. The one or more memory devices can store instructions thereon. The instructions can cause, when executed by one or more processors, the one or more processors to establish a connection with an edge device to communicate with the edge device. The edge device can maintain a first cache stored in memory of the edge device. The first cache can include a first set of data corresponding to a plurality of parameters of one or more aspects of a building, and the first set of data including one or more first values. The instructions can also cause the one or more processors to receive, via the connection from the edge device, the first set of data. The instructions can also cause the one or more processors to update, responsive to receipt of the first set of data, a second cache to reflect the one or more first values. The second cache can be stored in the one or more memory devices. The instructions can also cause the one or more processors to generate, based at least one the update to the second cache, a user interface including one or more graphical representations of the one or more first values. The one or more graphical representations can include selectable elements. The instructions can also cause the one or more processors to receive, via the connection from the edge device, a dataset corresponding to a Change of Value (COV) for at least one value of the one or more first values. The instructions can also cause the one or more processors to update, responsive to receipt of the dataset, the second cache to reflect the COV for the at least one value of the one or more first values. The instructions can also cause the one or more processors to update, responsive to receipt of the dataset, at least one graphical representation of the one or more graphical representations to reflect the COV for the at least one value of the one or more first values.

In some embodiments, the first set of data can include a first size. The dataset can include a second size. The second size can be less than the first size.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is drawing of a building equipped with a heating, ventilating, and air conditioning (HVAC) system, according to some embodiments.

FIG. 2 is a block diagram of a building management system (BMS) which can be used to monitor and control the building and HVAC system of FIG. 1, according to some embodiments.

FIG. 3 is a block diagram illustrating a system manager, zone coordinator, and zone controller of the BMS of FIG. 2 in greater detail, according to some embodiments.

FIG. 4 is a block diagram of a Building Automation System (BAS) which may be used to monitor and control building equipment in the building of FIG. 1, according to some embodiments.

FIG. 5 is a block diagram of a system for detecting Change of Values (COVs) for pieces of building equipment, according to some embodiments.

FIG. 6 is a flow diagram illustrating communication between one or more components of a system architecture, according to some embodiments.

FIG. 7 is a flow diagram of a process for detecting Change of Values (COVs) for buildings, according to some embodiments.

FIG. 8 is a sequence diagram of a process for updating a graphic on a user interface, according to some embodiments.

FIG. 9A is a block diagram illustrating communication between components of a system architecture, according to some embodiments.

FIG. 9B is a block diagram illustrating communication between components included in FIG. 9A, according to some embodiments.

FIG. 10 is a schematic diagram of a data model, according to some embodiments.

FIG. 11 is a user interface including a graphical representation of data, according to some embodiments.

FIG. 12 is an overlay that may be displayed over the user interface illustrated in FIG. 11, according to some embodiments.

FIG. 13 is a flow diagram of a process for detecting Change of Values (COVs) for pieces of building equipment, according to some embodiments.

### DETAILED DESCRIPTION

### Overview

Referring generally to the FIGURES, a building management system (BMS) with automatic equipment discovery and equipment model distribution is shown, according to some embodiments. A BMS is, in general, a system of devices configured to control, monitor, and manage equipment in or around a building or building area. A BMS can include a heating, ventilation, or air conditioning (HVAC) system, a security system, a lighting system, a fire alerting system, another system that is capable of managing building functions or devices, or any combination thereof. BMS devices may be installed in any environment (e.g., an indoor area or an outdoor area) and the environment may include any number of buildings, spaces, zones, rooms, or areas. A BMS may include VERASYS® building controllers or other devices sold by Johnson Controls, Inc., as well as building devices and components from other sources.

A Building Automation System (BAS) is, in general, a system of devices configured to control, monitor, and/or manage equipment in or around a building or building area. A BAS can include, for example, a HVAC system, a security system, a lighting system, a fire alerting system, any other system that is capable of managing building functions or devices, or any combination thereof.

In brief overview, the BMS described herein provides a system architecture that facilitates automatic equipment discovery and equipment model distribution. Equipment discovery can occur on multiple levels of the BMS across multiple different communications busses (e.g., a system bus, zone buses, a sensor/actuator bus, etc.) and across multiple different communications protocols. In some embodiments, equipment discovery is accomplished using active node tables, which provide status information for devices connected to each communications bus. For example, each communications bus can be monitored for new devices by monitoring the corresponding active node table for new nodes. When a new device is detected, the BMS can begin interacting with the new device (e.g., sending control signals, using data from the device) without user interaction.

Some devices in the BMS present themselves to the network using equipment models. An equipment model defines equipment object attributes, view definitions, schedules, trends, and the associated BACnet value objects (e.g., analog value, binary value, multistate value, etc.) that are used for integration with other systems. Some devices in the BMS store their own equipment models. Other devices in the BMS have equipment models stored externally (e.g., within other devices). For example, a zone coordinator can store the equipment model for a bypass damper. In some embodiments, the zone coordinator automatically creates the equipment model for the bypass damper and/or other devices on the zone bus. Other zone coordinators can also create equipment models for devices connected to their zone busses. The equipment model for a device can be created automatically based on the types of data points exposed by the device on the zone bus, device type, and/or other device attributes.

Systems, devices, components, and/or entities of a building may produce information. For example, pieces of building equipment may produce, provide, and/or generate one or more types of information. As another example, a sensor may collect temperature information and the sensor may generate information that identifies and/or includes the collected temperature information. As another example, when a building access system grants access to a building (e.g., unlocks a door), the building access system may generate information that identifies an individual that was granted access. The various types of information that is generated by pieces of building equipment may be transmitted, transferred, and/or otherwise provided to various systems. For example, the zone temperature readings may be provided to a processing system. To continue this example, the processing system may generate control signals based on the zone temperature readings.

Processing systems that generate decisions (e.g., fault detections, equipment control actions, access control, alert generation, etc.) can be remote and/or external to a building's BMS and/or BAS. For example, a building's BMS may communicate with a cloud system and the cloud system may be separate from the BMS. Systems that are separate from an internal system may be unable to readily access information that is generated within a building. Other external systems may ping, prompt, and/or poll an internal BMS at various intervals to request information. For example, a remote processing system may poll a building's BMS once an hour for zone temperature information.

The repetitive polling (e.g., asking for information at one or more time intervals) may result in and/or include redundant communication and/or redundant transmission of information. For example, a remote processing system may poll, at a first point in time, a BMS for information pertaining to a current state (e.g., on, off, starting up, shutting down, etc.) of an Air Handling Unit (AHU). To continue this example, the BMS may respond to the remote processing system with information that identifies the current state of the AHU. Furthermore, the remote processing system may poll, at a second point in time, the BMS with the same request (e.g., what is the current state of the AHU). In instances when the AHU's current state has remained the same, the BMS would respond to the remote processing system with a repetitive answer (e.g., the information being provided is the same information that was previously provided). The transmission of repetitive answers and/or repetitive information may result in redundant communication.

Some technical solutions of the present disclosure include a BMS with a locally stored cache (e.g., a live value cache, a database, a data structure, etc.) which may be used to detect Change of Values (COVs) for various types of information. For example, when a sensor provides a zone temperature reading to the BMS, the BMS may store the zone temperature reading in the live value cache. To continue this example, as the sensor continues to provide information (e.g., zone temperature readings) to the BMS, the BMS may retrieve data stored in the live value cache to detect COVs and/or COV events (e.g., data and/or information has changed). Stated otherwise, the BMS may compare information that is being provided by one or more systems of the building with information that was previously provided to the BMS. For example, a building may include a given conference room and the given conference room may include a controllable light fixture. To continue this example, a controller that controls (e.g., turns on, turns off, adjusts brightness, adjust control, etc.) may provide a signal to the BMS to indicate that the light fixture has been controlled. Furthermore, the BMS may store a state (e.g., how the light fixture was controlled) in the live value cache. The BMS may use the state of the light fixture to determine a COV. For example, the BMS may determine that the light fixture has gone from being off to being turned on. To continue this example, the BMS may provide signals to the remote processing system to indicate and/or identify the COV.

Advantageously, transmitting COV data rather than all of the data collected at the local engine level results in faster transmission time and decreased traffic. Further, individual values represented on a generated graphic may be individually adjusted based on COV data rather than generating a new graphic based on all of the local engine data at a given time. In this way, graphical representations of building data and/or parameters may be updated and transmitted faster than systems that continually transmit polled data and/or repetitive data.

The BMS may utilize a semantic store to provide self-identifiable information. For example, the semantic store may include and/or store information translations. As another example, an AHU may produce information (e.g., point values, name values, etc.) and the semantic store may include a translation of the AHU's information. The BMS may, via the translations in the semantic store, translate and/or convert information that is produced and/or provided by the building to a self-identifiable format. For example, a piece of building equipment may produce information in a given data string and/or data format. To continue this example, the data string may be undiscernible and/or unidentifiable prior to translation. Furthermore, the BMS may translate, via a translation in the semantic store, the data string to a format that is identifiable by the remote processing system.

In some embodiments, transmission of self-identifiable information may provide a remote processing system with the ability to process the information as the information is received. For example, the remote processing system may process the information upon receipt because the remote processing system becomes aware of the context and/or content of the information at the time of receipt.

The generation, transmission, and display of graphics representative of COVs, responsive to translation of the information, may provide some of the technical solutions described herein. For example, a graphics service may use the data stored in the live value cache to generate a graphic according to the initial data or COVs. The graphics service may be an edge device that is connected to a cloud system via one or more networks. The graphics service may generate and/or update one or more heatmaps.

As used herein, a heatmap and/or one or more heatmaps may refer to and/or include at least one of a graphical display representing sensor data, a graphical display representing measured data, a graphical display representing various temperature values, temperature indicators (e.g. humidity), and/or temperature ranges, a graphical display representing one or more COVs and/or COV events, a graphical display representing various data values and/or data ranges, and/or various combinations, in some embodiments.

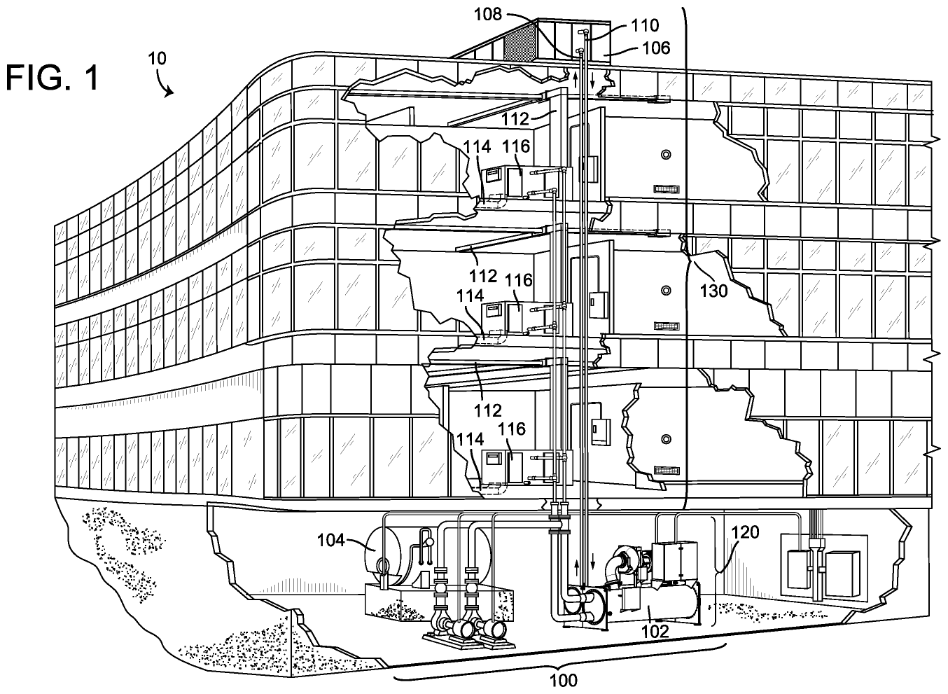

Referring now to FIG. 1, an exemplary building and HVAC system in which the systems and methods of the present invention can be implemented are shown, according to an exemplary embodiment. In FIG. 1, a perspective view of a building 10 is shown. Building 10 is served by a HVAC system 100. HVAC system 100 can include a plurality of HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 can provide a heated or chilled fluid to an air handling unit of airside system 130. Airside system 130 can use the heated or chilled fluid to heat or cool an airflow provided to building 10.

HVAC system 100 is shown to include a chiller 102, a boiler 104, and a rooftop air handling unit (AHU) 106. Waterside system 120 can use boiler 104 and chiller 102 to heat or cool a working fluid (e.g., water, glycol, etc.) and can circulate the working fluid to AHU 106. In various embodiments, the HVAC devices of waterside system 120 can be located in or around building 10 (as shown in FIG. 1) or at an offsite location such as a central plant (e.g., a chiller plant, a steam plant, a heat plant, etc.). The working fluid can be heated in boiler 104 or cooled in chiller 102, depending on whether heating or cooling is required in building 10. Boiler 104 can add heat to the circulated fluid, for example, by burning a combustible material (e.g., natural gas) or using an electric heating element. Chiller 102 can place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 can be transported to AHU 106 via piping 108.

AHU 106 can place the working fluid in a heat exchange relationship with an airflow passing through AHU 106 (e.g., via one or more stages of cooling coils and/or heating coils). The airflow can be, for example, outside air, return air from within building 10, or a combination of both. AHU 106 can transfer heat between the airflow and the working fluid to provide heating or cooling for the airflow. For example, AHU 106 can include one or more fans or blowers configured to pass the airflow over or through a heat exchanger containing the working fluid. The working fluid can then return to chiller 102 or boiler 104 via piping 110.

Airside system 130 can deliver the airflow supplied by AHU 106 (i.e., the supply airflow) to building 10 via air supply ducts 112 and can provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 can include dampers or other flow control elements that can be operated to control an amount of the supply airflow provided to individual zones of building 10. In other embodiments, airside system 130 delivers the supply airflow into one or more zones of building 10 (e.g., via supply ducts 112) without using intermediate VAV units 116 or other flow control elements. AHU 106 can include various sensors (e.g., temperature sensors, pressure sensors, etc.) configured to measure attributes of the supply airflow. AHU 106 can receive input from sensors located within AHU 106 and/or within the building zone and can adjust the flow rate, temperature, or other attributes of the supply airflow through AHU 106 to achieve setpoint conditions for the building zone.

### Building Management System

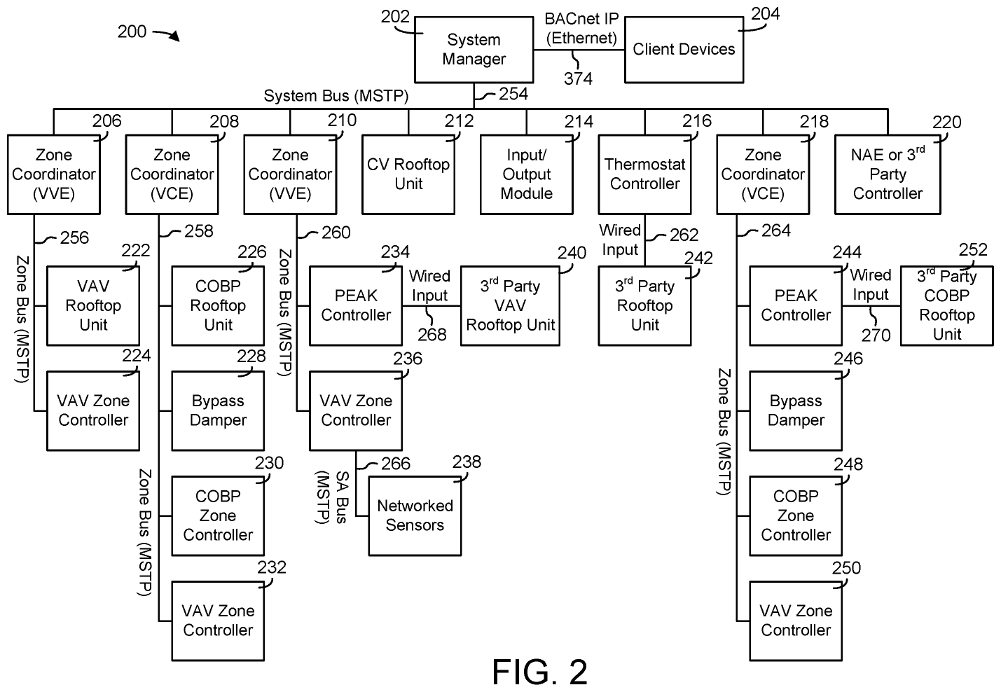

Referring now to FIG. 2, a block diagram of a building management system (BMS) 200 is shown, according to an exemplary embodiment. A BMS is, in general, a system of devices configured to control, monitor, and manage equipment in or around a building or building area. A BMS can include, for example, a HVAC system, a security system, a lighting system, a fire alerting system, any other system that is capable of managing building functions or devices, or any combination thereof. BMS 200 can be used to monitor and control the devices of HVAC system 100 and/or airside system 200 (e.g., HVAC equipment) as well as other types of BMS devices (e.g., lighting equipment, security equipment, etc.).

In brief overview, BMS 200 provides a system architecture that facilitates automatic equipment discovery and equipment model distribution. Equipment discovery can occur on multiple levels of BMS 200 across multiple different communications busses (e.g., a system bus 254, zone buses 256-260 and 264, sensor/actuator bus 266, etc.) and across multiple different communications protocols. In some embodiments, equipment discovery is accomplished using active node tables, which provide status information for devices connected to each communications bus. For example, each communications bus can be monitored for new devices by monitoring the corresponding active node table for new nodes. When a new device is detected, BMS 200 can begin interacting with the new device (e.g., sending control signals, using data from the device) without user interaction.

Some devices in BMS 200 present themselves to the network using equipment models. An equipment model defines equipment object attributes, view definitions, schedules, trends, and the associated BACnet value objects (e.g., analog value, binary value, multistate value, etc.) that are used for integration with other systems. An equipment model for a device can include a collection of point objects that provide information about the device (e.g., device name, network address, model number, device type, etc.) and store present values of variables or parameters used by the device. For example, the equipment model can include point objects (e.g., standard BACnet point objects) that store the values of input variables accepted by the device (e.g., setpoint, control parameters, etc.), output variables provided by the device (e.g., temperature measurement, feedback signal, etc.), configuration parameters used by the device (e.g., operating mode, actuator stroke length, damper position, tuning parameters, etc.). The point objects in the equipment model can be mapped to variables or parameters stored within the device to expose those variables or parameters to external systems or devices.

Some devices in BMS 200 store their own equipment models. Other devices in BMS 200 have equipment models stored externally (e.g., within other devices). For example, a zone coordinator 208 can store the equipment model for a bypass damper 228. In some embodiments, zone coordinator 208 automatically creates the equipment model for bypass damper 228 or other devices on zone bus 258. Other zone coordinators can also create equipment models for devices connected to their zone busses. The equipment model for a device can be created automatically based on the types of data points exposed by the device on the zone bus, device type, and/or other device attributes. Several examples of automatic equipment discovery and equipment model distribution are discussed in greater detail below.

Still referring to FIG. 2, BMS 200 is shown to include a system manager 202; several zone coordinators 206, 208, 210 and 218; and several zone controllers 224, 230, 232, 236, 248, and 250. System manager 202 can communicate with client devices 204 (e.g., user devices, desktop computers, laptop computers, mobile devices, etc.) via a data communications link 374 (e.g., BACnet IP, Ethernet, wired or wireless communications, etc.). System manager 202 can provide a user interface to client devices 204 via data communications link 374. The user interface may allow users to monitor and/or control BMS 200 via client devices 204.

In some embodiments, system manager 202 is connected with zone coordinators 206-210 and 218 via a system bus 254. System bus 254 can include any of a variety of communications hardware (e.g., wire, optical fiber, terminals, etc.) configured to facilitate communications between system manager and other devices connected to system bus 254. Throughout this disclosure, the devices connected to system bus 254 are referred to as system bus devices. System manager 202 can be configured to communicate with zone coordinators 206-210 and 218 via system bus 254 using a master-slave token passing (MSTP) protocol or any other communications protocol. System bus 254 can also connect system manager 202 with other devices such as a constant volume (CV) rooftop unit (RTU) 212, an input/output module (IOM) 214, a thermostat controller 216 (e.g., a TEC2000 series thermostat controller), and a network automation engine (NAE) or third-party controller 220. RTU 212 can be configured to communicate directly with system manager 202 and can be connected directly to system bus 254. Other RTUs can communicate with system manager 202 via an intermediate device. For example, a wired input 262 can connect a third-party RTU 242 to thermostat controller 216, which connects to system bus 254.

System manager 202 can provide a user interface for any device containing an equipment model. Devices such as zone coordinators 206-210 and 218 and thermostat controller 216 can provide their equipment models to system manager 202 via system bus 254. In some embodiments, system manager 202 automatically creates equipment models for connected devices that do not contain an equipment model (e.g., IOM 214, third party controller 220, etc.). For example, system manager 202 can create an equipment model for any device that responds to a device tree request. The equipment models created by system manager 202 can be stored within system manager 202. System manager 202 can then provide a user interface for devices that do not contain their own equipment models using the equipment models created by system manager 202. In some embodiments, system manager 202 stores a view definition for each type of equipment connected via system bus 254 and uses the stored view definition to generate a user interface for the equipment.

Each zone coordinator 206-210 and 218 can be connected with one or more of zone controllers 224, 230-232, 236, and 248-250 via zone buses 256, 258, 260, and 264. Zone busses 256, 258, 260, and 264 can include any of a variety of communications hardware (e.g., wire, optical fiber, terminals, etc.) configured to facilitate communications between a zone coordinator and other devices connected to the corresponding zone bus. Throughout this disclosure, the devices connected to zone busses 256, 258, 260, and 264 are referred to as zone bus devices. Zone coordinators 206-210 and 218 can communicate with zone controllers 224, 230-232, 236, and 248-250 via zone busses 256-260 and 264 using a MSTP protocol or any other communications protocol. Zone busses 256-260 and 264 can also connect zone coordinators 206-210 and 218 with other types of devices such as variable air volume (VAV) RTUs 222 and 240, changeover bypass (COBP) RTUs 226 and 252, bypass dampers 228 and 246, and PEAK controllers 234 and 244.

Zone coordinators 206-210 and 218 can be configured to monitor and command various zoning systems. In some embodiments, each zone coordinator 206-210 and 218 monitors and commands a separate zoning system and is connected to the zoning system via a separate zone bus. For example, zone coordinator 206 can be connected to VAV RTU 222 and zone controller 224 via zone bus 256. Zone coordinator 208 can be connected to COBP RTU 226, bypass damper 228, COBP zone controller 230, and VAV zone controller 232 via zone bus 258. Zone coordinator 210 can be connected to PEAK controller 234 and VAV zone controller 236 via zone bus 260. Zone coordinator 218 can be connected to PEAK controller 244, bypass damper 246, COBP zone controller 248, and VAV zone controller 250 via zone bus 264.

A single model of zone coordinator 206-210 and 218 can be configured to handle multiple different types of zoning systems (e.g., a VAV zoning system, a COBP zoning system, etc.). Each zoning system can include a RTU, one or more zone controllers, and/or a bypass damper. For example, zone coordinators 206 and 210 are shown as Verasys VAV engines (VVEs) connected to VAV RTUs 222 and 240, respectively. Zone coordinator 206 is connected directly to VAV RTU 222 via zone bus 256, whereas zone coordinator 210 is connected to a third-party VAV RTU 240 via a wired input 268 provided to PEAK controller 234. Zone coordinators 208 and 218 are shown as Verasys COBP engines (VCEs) connected to COBP RTUs 226 and 252, respectively. Zone coordinator 208 is connected directly to COBP RTU 226 via zone bus 258, whereas zone coordinator 218 is connected to a third-party COBP RTU 252 via a wired input 270 provided to PEAK controller 244.

Zone controllers 224, 230-232, 236, and 248-250 can communicate with individual BMS devices (e.g., sensors, actuators, etc.) via sensor/actuator (SA) busses. For example, VAV zone controller 236 is shown connected to networked sensors 238 via SA bus 266. Networked sensors 238 can include, for example, temperature sensors, humidity sensors, pressure sensors, lighting sensors, security sensors, or any other type of device configured to measure and/or provide an input to zone controller 236. Zone controller 236 can communicate with networked sensors 238 using a MSTP protocol or any other communications protocol. Although only one SA bus 266 is shown in FIG. 2, it should be understood that each zone controller 224, 230-232, 236, and 248-250 can be connected to a different SA bus. Each SA bus can connect a zone controller with various sensors (e.g., temperature sensors, humidity sensors, pressure sensors, light sensors, occupancy sensors, etc.), actuators (e.g., damper actuators, valve actuators, etc.) and/or other types of controllable equipment (e.g., chillers, heaters, fans, pumps, etc.).

Each zone controller 224, 230-232, 236, and 248-250 can be configured to monitor and control a different building zone. Zone controllers 224, 230-232, 236, and 248-250 can use the inputs and outputs provided via their SA busses to monitor and control various building zones. For example, a zone controller 236 can use a temperature input received from networked sensors 238 via SA bus 266 (e.g., a measured temperature of a building zone) as feedback in a temperature control algorithm. Zone controllers 224, 230-232, 236, and 248-250 can use various types of control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control a variable state or condition (e.g., temperature, humidity, airflow, lighting, etc.) in or around building 10.

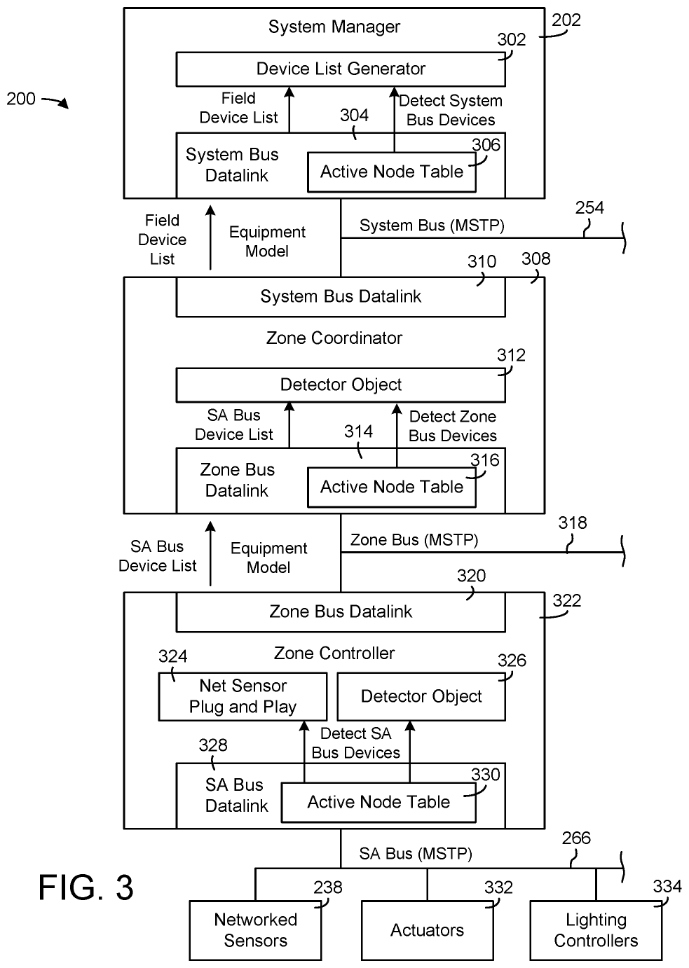

Referring now to FIG. 3, a block diagram illustrating a portion of BMS 200 in greater detail is shown, according to an exemplary embodiment. BMS 200 is shown to include system manager 202, a zone coordinator 308, and a zone controller 322. Zone coordinator 308 can be any of zone coordinators 206-210 or 218. Zone controller 322 can be any of zone controllers 224, 230, 232, 236, 248, or 250. Zone coordinator 308 can be connected with system manager via system bus 254. For example, system bus 254 is shown connecting a first system bus datalink 304 within system manager 202 with a second system bus datalink 310 within zone coordinator 308. Zone coordinator 308 can be connected with zone controller 322 via a zone bus 318. For example, zone bus 318 is shown connecting a first zone bus datalink 314 within zone coordinator 308 with a second zone bus datalink 320 within zone controller 322. Zone bus 318 can be any of zone busses 256-260 or 264. Zone controller 322 is connected with networked sensors 238 and actuators 332 via a SA bus 266.

BMS 200 can automatically discover new equipment connected to any of system bus 254, zone bus 318, and SA bus 266. Advantageously, the equipment discovery can occur automatically (e.g., without user action) without requiring the equipment to be placed in discovery mode and without sending a discovery command to the equipment. In some embodiments, the automatic equipment discovery is based on active node tables for system bus 254, zone bus 318, and SA bus 266. Each active node table can provide status information for the devices communicating on a particular bus. For example, the active node table 306 for system bus 254 can indicate which MSTP devices are participating in the token ring used to exchange information via system bus 254. Active node table 306 can identify the devices communicating on system bus 254 by MAC address or other device identifier. Devices that do not participate in the token ring (e.g., MSTP slave devices) can be automatically discovered using a net sensor plug and play (described in greater detail below).

The active node table for each communications bus can be stored within one or more devices connected to the bus. For example, active node table 306 can be stored within system manager 202. In some embodiments, active node table 306 is part of a system bus datalink 304 (e.g., a MSTP datalink) used by system manager 202 to communicate via system bus 254. System manager 202 can subscribe to changes in value of active node table 306 and can receive a notification (e.g., from system bus datalink 304) when a change in active node table 306. In response to a notification that a change in active node table 306 has occurred, system manager 202 can read active node table 306 to detect and identify the devices connected to system bus 254.

In some embodiments, a device list generator 302 within system manager 202 generates a list of the devices connected to system bus 254 (i.e., a device list) based on active node table 306 and stores the device list within system manager 202. The device list generated by system manager 202 can include information about each device connected to system bus 254 (e.g., device type, device model, device ID, MAC address, device attributes, etc.). When a new device is detected on system bus 254, system manager 202 can automatically retrieve the equipment model from the device if the device stores its own equipment model. If the device does not store its own equipment model, system manager 202 can retrieve a list of point values provided by the device. System manager 202 can then use the equipment model and/or list of point values to present information about the connected system bus devices to a user.

The active node tables for each zone bus can be stored within the zone coordinator connected to the zone bus. For example, the active node table 316 for zone bus 318 can be stored within zone coordinator 308. In some embodiments, active node table 316 is part of a zone bus datalink 314 (e.g., a MSTP datalink) used by the zone coordinator 308 to communicate via zone bus 318. Zone coordinator 308 can subscribe to changes in value of active node table 316 and can receive a notification (e.g., from zone bus datalink 314) when a change in active node table 316 occurs. In response to a notification that a change to active node table 316 has occurred, zone coordinator 308 can read active node table 316 to identify the devices connected to zone bus 318.

In some embodiments, a detector object 312 of zone coordinator 308 generates a list of the devices communicating on zone bus 318 (i.e., a device list) based on active node table 316 and stores the device list within zone coordinator 308. Each zone coordinator in BMS 200 can generate a list of devices on the connected zone bus. The device list generated by each zone coordinator 308 can include information about each device connected to zone bus 318 (e.g., device type, device model, device ID, MAC address, device attributes, etc.). When a new device is detected on zone bus 318, the connected zone coordinator 308 can automatically retrieve the equipment model from the device if the device stores its own equipment model. If the device does not store its own equipment model, the connected zone coordinator 308 can retrieve a list of point values provided by the device.

Zone coordinator 308 can incorporate the new zone bus device into the zoning logic and can inform system manager 202 that a new zone bus device has been added. For example, zone coordinator 308 is shown providing a field device list to system manager 202. The field device list can include a list of devices connected to zone bus 318 and/or SA bus 266. System manager 202 can use the field device list and the list of system bus devices to generate a device tree including all of the devices in BMS 200. In some embodiments, zone coordinator 308 provides an equipment model for a connected zone bus device to system manager 202. System manager 202 can then use the equipment model and/or list of point values for the new zone bus device to present information about the new zone bus device to a user.

In some embodiments, the device list generated by each zone coordinator 308 indicates whether system manager 202 should communicate directly with the listed zone bus device (e.g., VAV RTU 222, VAV zone controller 224, etc.) or whether system manager 202 should communicate with the intermediate zone coordinator 308 on behalf of the zone bus device. In some embodiments, system manager 202 communicates directly with zone bus devices that provide their own equipment models, but communicates with the intermediate zone coordinator 308 for zone bus devices that do not provide their own equipment model. As discussed above, the equipment models for zone bus devices that do not provide their own equipment model can be generated by the connected zone coordinator 308 and stored within the zone coordinator 308. Accordingly, system manager 202 may communicate directly with the device that stores the equipment model for a connected zone bus device (i.e., the zone bus device itself or the connected zone coordinator 308).

The active node table 330 for SA bus 266 can be stored within zone controller 322. In some embodiments, active node table 330 is part of the SA bus datalink 328 (e.g., a MSTP datalink) used by zone controller 322 to communicate via SA bus 266. Zone controller 322 can subscribe to changes in value of the active node table 330 and can receive a notification (e.g., from SA bus datalink 328) when a change in active node table 330 occurs. In response to a notification that a change to active node table 330 has occurred, zone controller 322 can read active node table 330 to identify some or all of the devices connected to SA bus 266. In some embodiments, active node table 330 identifies only the SA bus devices participating in the token passing ring via SA bus 266 (e.g., MSTP master devices). Zone controller 322 can include an additional net sensor plug and play (NsPnP) 324 configured to detect SA bus devices that do not participate in the token passing ring (e.g., MSTP slave devices).

In some embodiments, NsPnP 324 is configured to actively search for devices connected to SA bus 266 (e.g., networked sensors 238, actuators 332, lighting controllers 334, etc.). For example, NsPnP 324 can send a “ping” to a preconfigured list of MSTP slave MAC addresses. For each SA bus device that is discovered (i.e., responds to the ping), NsPnP 324 can dynamically bring it online. NsPnP 324 can bring a device online by creating and storing an instance of a SA bus device object representing the discovered SA bus device. NsPnP 324 can automatically populate the SA bus device object with all child point objects needed to collect and store point data (e.g., sensor data) from the newly discovered SA bus device. In some embodiments, NsPnP 324 automatically maps the child point objects of the SA bus device object to attributes of the equipment model for zone controller 322. Accordingly, the data points provided by the SA bus devices can be exposed to zone coordinator 308 and other devices in BMS 200 as attributes of the equipment model for zone controller 322.

In some embodiments, a detector object 326 of zone controller 322 generates a list of the devices connected to SA bus 266 (i.e., a device list) based on active node table 330 and stores the device list within zone controller 322. NsPnP 324 can update the device list to include any SA bus devices discovered by NsPnP 324. The device list generated by zone controller 322 can include information about each device connected to SA bus 266 (e.g., device type, device model, device ID, MAC address, device attributes, etc.). When a new device is detected on SA bus 266, zone controller 322 can automatically retrieve the equipment model from the device if the device stores its own equipment model. If the device does not store its own equipment model, zone controller 322 can retrieve a list of point values provided by the device.

Zone controller 322 can incorporate the new SA bus device into the zone control logic and can inform zone coordinator 308 that a new SA bus device has been added. Zone coordinator 308 can then inform system manager 202 that a new SA bus device has been added. For example, zone controller 322 is shown providing a SA device list to zone coordinator 308. The SA device list can include a list of devices connected to SA bus 266. Zone coordinator 308 can use the SA device list and the detected zone bus devices to generate the field device list provided to system manager 202. In some embodiments, zone controller 322 provides an equipment model for a connected SA bus device to zone coordinator 308, which can be forwarded to system manager 202. System manager 202 can then use the equipment model and/or list of point values for the new SA bus device to present information about the new SA bus device to a user. In some embodiments, data points provided by the SA bus device are shown as attributes of the zone controller 322 to which the SA bus device is connected.

Additional features and advantages of BMS 200, system manager 202, zone coordinator 308, and zone controller 322 are described in detail in U.S. patent application Ser. No. 15/179,894 filed Jun. 10, 2016, the entire disclosure of which is incorporated by reference herein.

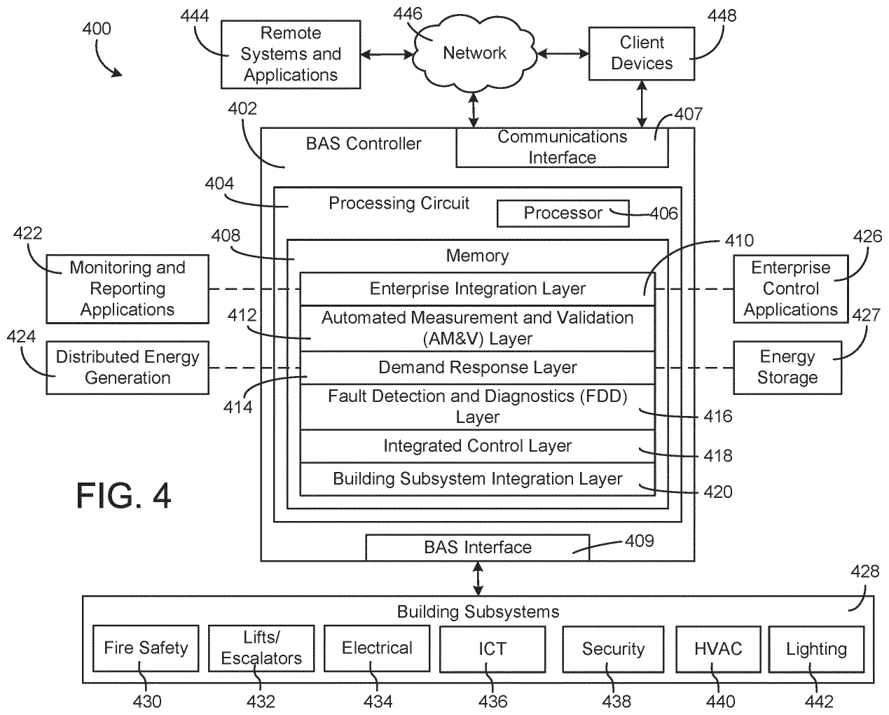

Referring now to FIG. 4, a block diagram of a building automation system (BAS) 400 is shown, according to an exemplary embodiment. BAS 400 may be implemented in building 10 to automatically monitor and control various building functions. BAS 400 is shown to include BAS controller 402 and a plurality of building subsystems 428. Building subsystems 428 are shown to include a building electrical subsystem 434, an information communication technology (ICT) subsystem 436, a security subsystem 438, a HVAC subsystem 440, a lighting subsystem 442, a lift/escalators subsystem 432, and a fire safety subsystem 430. In various embodiments, building subsystems 428 can include fewer, additional, or alternative subsystems. For example, building subsystems 428 may also or alternatively include a refrigeration subsystem, an advertising or signage subsystem, a cooking subsystem, a vending subsystem, a printer or copy service subsystem, or any other type of building subsystem that uses controllable equipment and/or sensors to monitor or control building 10. In some embodiments, building subsystems 428 may include at least one of the various building systems and/or building subsystems described herein. For example, the building subsystems 428 may include airside system 130.

Each of building subsystems 428 may include any number of devices, controllers, and connections for completing its individual functions and control activities. HVAC subsystem 440 may include many of the same components as HVAC system 100. For example, HVAC subsystem 440 may include a chiller, a boiler, any number of air handling units, economizers, field controllers, supervisory controllers, actuators, temperature sensors, and other devices for controlling the temperature, humidity, airflow, or other variable conditions within building 10. Lighting subsystem 442 may include any number of light fixtures, ballasts, lighting sensors, dimmers, or other devices configured to controllably adjust the amount of light provided to a building space. Security subsystem 438 may include occupancy sensors, video surveillance cameras, digital video recorders, video processing servers, intrusion detection devices, access control devices and servers, or other security-related devices.

Still referring to FIG. 4, BAS controller 402 is shown to include a communications interface 407 and a BAS interface 409. Interface 407 may facilitate communications between BAS controller 402 and external applications (e.g., monitoring and reporting applications 422, enterprise control applications 426, remote systems and applications 444, applications residing on client devices 448, etc.) for allowing user control, monitoring, and adjustment to BAS controller 402 and/or subsystems 428. Interface 407 may also facilitate communications between BAS controller 402 and client devices 448. BAS interface 409 may facilitate communications between BAS controller 402 and building subsystems 428 (e.g., HVAC, lighting security, lifts, power distribution, business, etc.).

Interfaces 407, 409 can be or include wired or wireless communications interfaces (e.g., jacks, antennas, transmitters, receivers, transceivers, wire terminals, etc.) for conducting data communications with building subsystems 428 or other external systems or devices. In various embodiments, communications via interfaces 407, 409 may be direct (e.g., local wired or wireless communications) or via a communications network 446 (e.g., a WAN, the Internet, a cellular network, etc.). For example, interfaces 407, 409 can include an Ethernet card and port for sending and receiving data via an Ethernet-based communications link or network. In another example, interfaces 407, 409 can include a Wi-Fi transceiver for communicating via a wireless communications network. In another example, one or both of interfaces 407, 409 may include cellular or mobile phone communications transceivers. In one embodiment, communications interface 407 is a power line communications interface and BAS interface 409 is an Ethernet interface. In other embodiments, both communications interface 407 and BAS interface 409 are Ethernet interfaces or are the same Ethernet interface.

Still referring to FIG. 4, BAS controller 402 is shown to include a processing circuit 404 including a processor 406 and memory 408. Processing circuit 404 may be communicably connected to BAS interface 409 and/or communications interface 407 such that processing circuit 404 and the various components thereof can send and receive data via interfaces 407, 409. Processor 406 can be implemented as a general-purpose processor, an application specific integrated circuit (ASIC), one or more field programmable gate arrays (FPGAs), a group of processing components, or other suitable electronic processing components.

Memory 408 (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present application. Memory 408 may be or include volatile memory or non-volatile memory. Memory 408 may include database components, object code components, script components, or any other type of information structure for supporting the various activities and information structures described in the present application. According to an exemplary embodiment, memory 408 is communicably connected to processor 406 via processing circuit 404 and includes computer code for executing (e.g., by processing circuit 404 and/or processor 406) one or more processes described herein.

In some embodiments, BAS controller 402 is implemented within a single computer (e.g., one server, one housing, etc.). In various other embodiments, BAS controller 402 may be distributed across multiple servers or computers (e.g., that can exist in distributed locations). Further, while FIG. 4 shows applications 422 and 426 as existing outside of BAS controller 402, in some embodiments, applications 422 and 426 may be hosted within BAS controller 402 (e.g., within memory 408).

Still referring to FIG. 4, memory 408 is shown to include an enterprise integration layer 410, an automated measurement and validation (AM&V) layer 412, a demand response (DR) layer 414, a fault detection and diagnostics (FDD) layer 416, an integrated control layer 418, and a building subsystem integration later 420. Layers 410-420 may be configured to receive inputs from building subsystems 428 and other data sources, determine optimal control actions for building subsystems 428 based on the inputs, generate control signals based on the optimal control actions, and provide the generated control signals to building subsystems 428. The following paragraphs describe some of the general functions performed by each of layers 410-420 in BAS 400.

Enterprise integration layer 410 may be configured to serve clients or local applications with information and services to support a variety of enterprise-level applications. For example, enterprise control applications 426 may be configured to provide subsystem-spanning control to a graphical user interface (GUI) or to any number of enterprise-level business applications (e.g., accounting systems, user identification systems, etc.). Enterprise control applications 426 may also or alternatively be configured to provide configuration GUIs for configuring BAS controller 402. In yet other embodiments, enterprise control applications 426 can work with layers 410-420 to optimize building performance (e.g., efficiency, energy use, comfort, or safety) based on inputs received at interface 407 and/or BAS interface 409.

Building subsystem integration layer 420 may be configured to manage communications between BAS controller 402 and building subsystems 428. For example, building subsystem integration layer 420 may receive sensor data and input signals from building subsystems 428 and provide output data and control signals to building subsystems 428. Building subsystem integration layer 420 may also be configured to manage communications between building subsystems 428. Building subsystem integration layer 420 translate communications (e.g., sensor data, input signals, output signals, etc.) across a plurality of multi-vendor/multi-protocol systems.

Demand response layer 414 may be configured to optimize resource usage (e.g., electricity use, natural gas use, water use, etc.) and/or the monetary cost of such resource usage in response to satisfy the demand of building 10. The optimization may be based on time-of-use prices, curtailment signals, energy availability, or other data received from utility providers, distributed energy generation systems 424, from energy storage 427 (e.g., hot TES 242, cold TES 244, etc.), or from other sources. Demand response layer 414 may receive inputs from other layers of BAS controller 402 (e.g., building subsystem integration layer 420, integrated control layer 418, etc.). The inputs received from other layers may include environmental or sensor inputs such as temperature, carbon dioxide levels, relative humidity levels, air quality sensor outputs, occupancy sensor outputs, room schedules, and the like. The inputs may also include inputs such as electrical use (e.g., expressed in kWh), thermal load measurements, pricing information, projected pricing, smoothed pricing, curtailment signals from utilities, and the like.

According to an exemplary embodiment, demand response layer 414 includes control logic for responding to the data and signals it receives. These responses can include communicating with the control algorithms in integrated control layer 418, changing control strategies, changing setpoints, or activating/deactivating building equipment or subsystems in a controlled manner. Demand response layer 414 may also include control logic configured to determine when to utilize stored energy. For example, demand response layer 414 may determine to begin using energy from energy storage 427 just prior to the beginning of a peak use hour.

In some embodiments, demand response layer 414 includes a control module configured to actively initiate control actions (e.g., automatically changing setpoints) which minimize energy costs based on one or more inputs representative of or based on demand (e.g., price, a curtailment signal, a demand level, etc.). In some embodiments, demand response layer 414 uses equipment models to determine an optimal set of control actions. The equipment models may include, for example, thermodynamic models describing the inputs, outputs, and/or functions performed by various sets of building equipment. Equipment models may represent collections of building equipment (e.g., subplants, chiller arrays, etc.) or individual devices (e.g., individual chillers, heaters, pumps, etc.).

Demand response layer 414 may further include or draw upon one or more demand response policy definitions (e.g., databases, XML files, etc.). The policy definitions may be edited or adjusted by a user (e.g., via a graphical user interface) so that the control actions initiated in response to demand inputs may be tailored for the user's application, desired comfort level, particular building equipment, or based on other concerns. For example, the demand response policy definitions can specify which equipment may be turned on or off in response to particular demand inputs, how long a system or piece of equipment should be turned off, what setpoints can be changed, what the allowable set point adjustment range is, how long to hold a high demand setpoint before returning to a normally scheduled setpoint, how close to approach capacity limits, which equipment modes to utilize, the energy transfer rates (e.g., the maximum rate, an alarm rate, other rate boundary information, etc.) into and out of energy storage devices (e.g., thermal storage tanks, battery banks, etc.), and when to dispatch on-site generation of energy (e.g., via fuel cells, a motor generator set, etc.).

Integrated control layer 418 may be configured to use the data input or output of building subsystem integration layer 420 and/or demand response later 414 to make control decisions. Due to the subsystem integration provided by building subsystem integration layer 420, integrated control layer 418 can integrate control activities of the subsystems 428 such that the subsystems 428 behave as a single integrated supersystem. In an exemplary embodiment, integrated control layer 418 includes control logic that uses inputs and outputs from a plurality of building subsystems to provide greater comfort and energy savings relative to the comfort and energy savings that separate subsystems could provide alone. For example, integrated control layer 418 may be configured to use an input from a first subsystem to make an energy-saving control decision for a second subsystem. Results of these decisions can be communicated back to building subsystem integration layer 420.

Integrated control layer 418 is shown to be logically below demand response layer 414. Integrated control layer 418 may be configured to enhance the effectiveness of demand response layer 414 by enabling building subsystems 428 and their respective control loops to be controlled in coordination with demand response layer 414. This configuration may advantageously reduce disruptive demand response behavior relative to conventional systems. For example, integrated control layer 418 may be configured to assure that a demand response-driven upward adjustment to the setpoint for chilled water temperature (or another component that directly or indirectly affects temperature) does not result in an increase in fan energy (or other energy used to cool a space) that would result in greater total building energy use than was saved at the chiller.

Integrated control layer 418 may be configured to provide feedback to demand response layer 414 so that demand response layer 414 checks that constraints (e.g., temperature, lighting levels, etc.) are properly maintained even while demanded load shedding is in progress. The constraints may also include setpoint or sensed boundaries relating to safety, equipment operating limits and performance, comfort, fire codes, electrical codes, energy codes, and the like. Integrated control layer 418 is also logically below fault detection and diagnostics layer 416 and automated measurement and validation layer 412. Integrated control layer 418 may be configured to provide calculated inputs (e.g., aggregations) to these higher levels based on outputs from more than one building subsystem.

Automated measurement and validation (AM&V) layer 412 may be configured to verify that control strategies commanded by integrated control layer 418 or demand response layer 414 are working properly (e.g., using data aggregated by AM&V layer 412, integrated control layer 418, building subsystem integration layer 420, FDD layer 416, or otherwise). The calculations made by AM&V layer 412 may be based on building system energy models and/or equipment models for individual BAS devices or subsystems. For example, AM&V layer 412 may compare a model-predicted output with an actual output from building subsystems 428 to determine an accuracy of the model.

Fault detection and diagnostics (FDD) layer 416 may be configured to provide on-going fault detection for building subsystems 428, building subsystem devices (i.e., building equipment), and control algorithms used by demand response layer 414 and integrated control layer 418. FDD layer 416 may receive data inputs from integrated control layer 418, directly from one or more building subsystems or devices, or from another data source. FDD layer 416 may automatically diagnose and respond to detected faults. The responses to detected or diagnosed faults may include providing an alert message to a user, a maintenance scheduling system, or a control algorithm configured to attempt to repair the fault or to work-around the fault.

FDD layer 416 may be configured to output a specific identification of the faulty component or cause of the fault (e.g., loose damper linkage) using detailed subsystem inputs available at building subsystem integration layer 420. In other exemplary embodiments, FDD layer 416 is configured to provide “fault” events to integrated control layer 418 which executes control strategies and policies in response to the received fault events. According to an exemplary embodiment, FDD layer 416 (or a policy executed by an integrated control engine or business rules engine) may shut-down systems or direct control activities around faulty devices or systems to reduce energy waste, extend equipment life, or assure proper control response.

FDD layer 416 may be configured to store or access a variety of different system data stores (or data points for live data). FDD layer 416 may use some content of the data stores to identify faults at the equipment level (e.g., specific chiller, specific AHU, specific terminal unit, etc.) and other content to identify faults at component or subsystem levels. For example, building subsystems 428 may generate temporal (i.e., time-series) data indicating the performance of BAS 400 and the various components thereof. The data generated by building subsystems 428 may include measured or calculated values that exhibit statistical characteristics and provide information about how the corresponding system or process (e.g., a temperature control process, a flow control process, etc.) is performing in terms of error from its setpoint. These processes can be examined by FDD layer 416 to expose when the system begins to degrade in performance and alert a user to repair the fault before it becomes more severe.

### Detection of Change of Values for Buildings

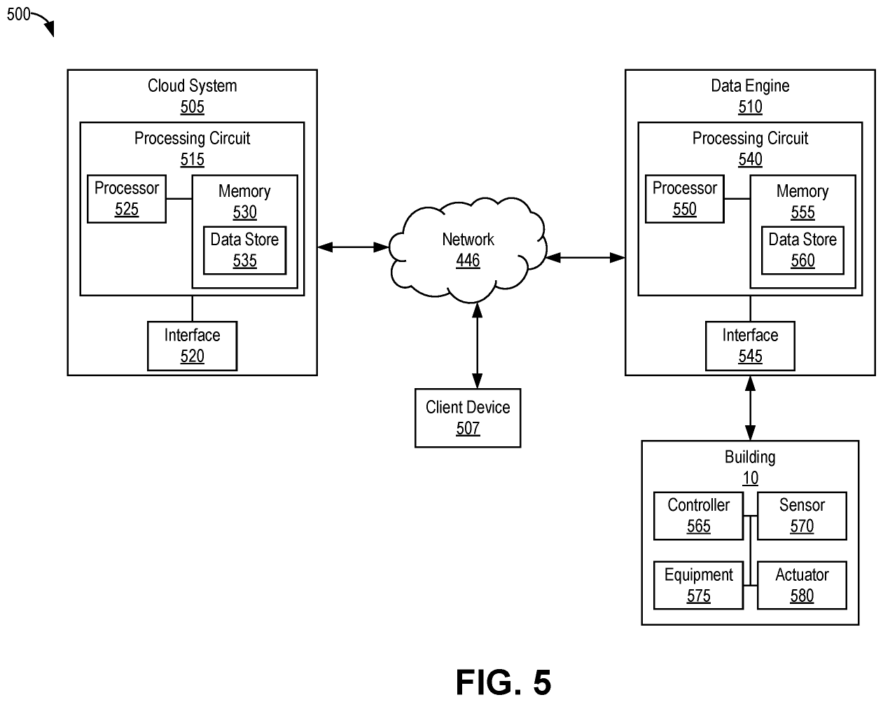

FIG. 5 depicts a block diagram of a system 500, according to some embodiments. The system 500 may include and/or be implemented as at least one of the various systems described herein. For example, the system 500 may be implemented as the BAS 400. In some embodiments, the system 500 may include at least one of the various systems and/or components described herein. For example, the system 500 may include the system manager 202. In some embodiments, systems, components, and/or devices of the system 500 may be added, removed, integrated, combined, separated, rearranged, relocated, and/or replaced. For example, a device of the system 500 that may be shown to include two components may be modified such that the two components are combined into a single component. As another example, a component that is shown to be included in a first device may also be added to a second device. Each system or device in the system 500 may include one or more processors, memories, network interfaces, and user interfaces. The memories may store programming logic that, when executed by the processors, controls the operation of a corresponding computing system or device. The memories may also store data in databases.

In some embodiments, the system 500 may include at least one cloud system 505, at least one client device 507, at least one data engine 510, the network 446, and/or the building 10. In some embodiments, systems, devices, and/or components of the system 500 may be in communication with one another. For example, a first device may transmit signals to a second device. In some embodiments, the communication may include wireless communication. For example, the communication may include communication via a Wireless Local Area network (WLAN). In some embodiments, the communication may include wired communication. For example, the communication may include communication via wires and/or cables. In some embodiments, systems, devices, and/or components of the system 500 may communicate via the network 446.

In some embodiments, the cloud system 505 may include at least one of servers, remote computing systems, a cloud-based system, remote databases, and/or other possible cloud computing systems. In some embodiments, the cloud system 505 may be distributed and/or implemented across one or more components. For example, the cloud system 505 may be distributed across one or more servers. In some embodiments, the cloud system 505 may be remote and/or external to the building 10. For example, the cloud system 505 may be housed separate from the building 10. In some embodiments, the cloud system 505 may be housed and/or located within the building 10. For example, the building 10 may include a server bank that houses and/or implements the cloud system 505.

In some embodiments, the cloud system 505 may include similar components to at least one of the various systems and/or devices described herein. For example, the cloud system 505 may include the BAS controller 402. In some embodiments, the cloud system 505 may perform operations similar to that of at least one component and/or device described herein. For example, the cloud system 505 may perform operations similar to that of the monitoring and reporting applications 422.

In some embodiments, the cloud system 505 may include at least one processing circuit 515 and at least one interface 520. In some embodiments, the processing circuit 515 may perform at least one of the various operations described herein. In some embodiments, the processing circuit 515 may include hardware and/or circuitry similar to at least one of the devices and/or the components described herein. The interface 520 may include at least one of a Human-Machine Interface (HMI), a communication interface, a network interface, a transmitter, an antenna, a receiver, and/or a transceiver. In some embodiments, the interface 520 may include at least one display device (e.g., a screen, a monitor, a Liquid Crystal Display (LCD) screen, a touch screen, an Input/Output (I/O) device, and/or other possible devices). In some embodiments, the interface 520 may communicate with at least one of the devices and/or components of the system 500. For example, the interface 520 may communicate with the client device 507. In some embodiments, the processing circuit 515 may perform operations similar to that of the interface 520.

In some embodiments, the processing circuit 515 may include at least one processor 525 and at least one memory 530. In some embodiments, the processors 525 may include at least one of the various processors, hardware, and/or circuitry described herein. In some embodiments, memory 530 may include at least one of the various types of memory described herein. In some embodiments, memory 530 may store instructions (e.g., computer code, software, and/or firmware. In some embodiments, the processors 525 may perform at least one of the various operations described herein responsive to the processors 525 executing instructions stored in memory 530. In some embodiments, the memory 530 may include at least one data store 535. In some embodiments, the data stores 535 may refer to and/or include at least one of databases, records, data structures, data arrays, memory banks, data storage, data records, and/or a collection of data stored in and/or by the memory 530.

In some embodiments, the data engine 510 may refer to and/or include at least one of controllers, data processors, digital signal processors, comparators, switches, routers, network devices, hubs, bridges, gateways, and/or other possible devices that may connect one or more devices to one another. For example, the data engine 510 may connect the building 10 with the cloud system 505. As another example, the data engine 510 may receive a first signal, from the building 10, and the data engine 510 may provide the first signal to the cloud system 505. In some embodiments, the data engine 510 may include similar components to that of at least one of the systems and/or devices described herein. In some embodiments, the data engine 510 may perform operations similar to at least one of the systems and/or devices described herein. For example, the data engine 510 may perform operations similar to that of the system manager 202.

While FIG. 5 depicts the data engine 510 as being separate (e.g., remote) from the building 10, the data engine 510 may be included and/or implemented within the building 10. For example, the data engine 510 may be housed and/or located within the building 10 (e.g., on premise). In some embodiments, data engine 510 may orchestrate and/or facilitate communication between the building 10 and at least one of the client device 507 and/or the cloud system 505. In other embodiments, the data engine 510 may refer to and/or include one or more edge devices. For example, the data engine 510 may serve as a gateway between controllers of the building 10 and the cloud system 505.

In some embodiments, the data engine 510 may include at least one processing circuit 540 and at least one interface 545. In some embodiments, the processing circuit 540 may perform at least one of the various operations described herein. In some embodiments, the processing circuit 540 may include hardware and/or circuitry similar to at least one of the devices and/or the components described herein. The interface 545 may include at least one of a Human-Machine Interface (HMI), a communication interface, a network interface, a transmitter, an antenna, a receiver, and/or a transceiver. In some embodiments, the interface 545 may include at least one display device (e.g., a screen, a monitor, a Liquid Crystal Display (LCD) screen, a touch screen, an Input/Output (I/O) device, and/or other possible devices). In some embodiments, the interface 545 may communicate with at least one of the devices and/or components of the system 500. For example, the interface 545 may communicate with the cloud system 505. In some embodiments, the processing circuit 540 may perform operations similar to that of the interface 545.

In some embodiments, the processing circuit 540 may include at least one processor 550 and at least one memory 555. In some embodiments, the processors 550 may include at least one of the various processors, hardware, and/or circuitry described herein. In some embodiments, memory 555 may include at least one of the various types of memory described herein. In some embodiments, memory 555 may store instructions (e.g., computer code, software, and/or firmware. In some embodiments, the processors 550 may perform at least one of the various operations described herein responsive to the processors 550 executing instructions stored in memory 555. In some embodiments, the memory 555 may include at least one data store 560. In some embodiments, the data stores 560 may refer to and/or include at least one of databases, records, data structures, data arrays, memory banks, data storage, data records, and/or a collection of data stored in and/or by the memory 555.

In some embodiments, the building 10 may include at least one controller 565, at least one sensor 570, at least one piece of building equipment 575, and/or at least one actuator 580. In some embodiments, the controller 565 may include at least one of the various controllers described herein. For example, the controller 565 may include the BAS controller 402. In some embodiments, the controller 565 may perform operations similar to that of at least one of the control devices described herein. For example, the controller 565 may perform operations similar to that of the VAV zone controller 224. In some embodiments, the sensors 570 may include the networked sensors 238.

In some embodiments, the sensors 570 may include at least one of the various sensors and/or sensor types described herein. In some embodiments, the building equipment 575 may include at least one of the various types of building equipment and/or building systems described herein. For example, the building equipment 575 may include the chiller 102. As another example, the building equipment 575 may include the AHU 106. As another example, the building equipment 575 may include the building subsystems 428. In some embodiments, the actuators 580 may include at least one of the various controllable elements described herein. For example, the actuators 580 may include the actuators 332. As another example, the actuators 580 may include the bypass damper 228.

In some embodiments, the controllers 565, the sensors 570, the equipment 575, and the actuator 580 may be in communication with one another. For example, the equipment 575 may include the controllers 565 and/or the controllers 565 may be electrically coupled with the equipment 575. In some embodiments, the controllers 565 may control the equipment 575. For example, the controllers 565 may transmit control signals to the equipment 575 and the equipment 575 may perform one or more operations based on the control signals. To continue this example, the equipment 575 may include HVAC subsystem 440 and the control signals may cause HVAC subsystem 440 to adjust and/or control an ambient room temperature.

In some embodiments, the elements of the building 10 (e.g., the controllers 565, the sensors 570, the equipment 575, and the actuators 580) may generate, produce, provide, detect, and/or otherwise transmit data and/or information. For example, the equipment 575 may control a room temperature for a floor of the building 10 and the sensors 570 may detect and/or measure the room temperature. In some embodiments, the sensors 570 may provide and/or communicate data to the data engine 510. For example, the sensors 570 may provide the room temperature measurements to the data engine 510. In some embodiments, the data engine 510 may store and/or maintain the data in the data store 560.

In some embodiments, the elements of the building 10 (e.g., the controllers 565, the sensors 570, the equipment 575, and the actuators 580) may produce at least one of timeseries data, operational data, setpoint data, control signals, measurement values, runtime information, diagnostic information, and/or among various other types of data and/or information described herein. For example, the equipment 575 may produce equipment runtime information (e.g., information that identifies routines, runtime cycles, performance metrics, equipment setpoints, etc.).

As a non-limiting example, the equipment 575 may include HVAC subsystem 440 and the equipment 575 may control a temperature for a given room in the building 10. To continue this example, the equipment 575 may produce various runtime information. The runtime information may include at least one fan speed, temperature setting, heat or cool, a humidity setting, and/or filtration rates. To continue this example, the equipment 575 may provide the runtime information to the data engine 510. The runtime information may include and/or indicate the various types of information described herein.

As another non-limiting example, the sensors 570 may be located and/or disposed in the room described above with respect to the non-limiting example of the equipment 575 including HVAC subsystem 440. To continue this non-limiting example, the sensors 570 may measure and/or obtain building information. The sensors 570 may measure room temperature, room occupancy, room humidity, and/or lighting setpoints. To continue this non-limiting example, the sensors 570 may provide the obtained data (e.g., the measured building information) to the data engine 510. The sensors 570 may provide temperature information to the data engine 510.

In some embodiments, building 10 may have one or more elements added, replaced, removed, retrofitted, and/or otherwise changed. For example, a boiler may be replaced with a different boiler. In some embodiments, the various elements of the building (e.g., the controller 565, the sensors 570, the equipment 575, and/or the actuators 580) may include and/or provide identification information. For example, the equipment 575 may include an AHU and the AHU may provide, to the data engine 510, information that identifies the equipment 575 as an AHU. As another example, the equipment 575 may provide information that identifies data that the equipment produces and/or provides. In some embodiments, the system 500 and/or the components thereof may provide semantic information. In some embodiments, the system 500 may perform operations and/or processes similar to that described in U.S. patent application Ser. No. 17/940,176 filed Sep. 8, 2022, the entire disclosure of which is incorporated by reference herein.

In some embodiments, the data engine 510 may store the various types of information, provided by the building 10, in the data store 560. For example, the data engine 510 may store information, in the data store 560, the identifies new pieces of building equipment (e.g., equipment 575) that have been added to the building 10. As another example, the data engine 510 may store temperature information, captured by the sensors 570, in the data store 560.

In some embodiments, the data engine 510 may provide the various types of information described herein to the cloud system 505. For example, the cloud system 505 may be a computing system (e.g., the cloud system 505 generates and/or computes information) that identifies faults and/or detects fault conditions. The data engine 510 may provide some of the technical solutions described herein by providing, to the cloud system 505, building information responsive to detection of a Change of Value (COV). For example, the data engine 510 may provide temperature information, to the cloud system 505, after determining that a temperature of a room has change. In some embodiments, the data engine 510 providing information after detection of a COV may reduce network traffic and/or communication with the cloud system 505. For example, the data engine 510 providing information responsive to a detection of a COV may eliminate the cloud system 505 prompting and/or polling the data engine 510 at one or more intervals.

In some embodiments, the data engine 510 may receive data corresponding to one or more parameters of a piece of equipment. For example, the data engine 510 may receive temperature information from the sensors 570. As another example, the data engine 510 may receive runtime information from the equipment 575. In some embodiments, the data received by the data engine 510 may include the various types of data and/or information described herein. In some embodiments, the data may include semantic information.

In some embodiments, the data engine 510 may extract one or more values. For example, the data engine 510 may extract values from the parameters of the piece of equipment. Stated otherwise, the parameters may include a fan speed setting and the data engine 510 may extract, from the information, the fan speed (e.g., a speed of a fan included in the equipment 575). As another example, the parameters may include room temperature and the data engine 510 may extract the room temperature (e.g., a temperature of the room).

In some embodiments, the data engine 510 may detect one or more differences. For example, the data engine 510 may detect, based on a comparison, differences between a first set of data and a second set of data. As another example, the data engine 510 may store a live cache (e.g., previous information, values, setpoints, etc.) in the data store 560 and the data engine 510 may compare present information (e.g., current information) with previous information. In some embodiments, the data engine 510 may detect a difference between values. For example, the data engine 510 may detect that a room temperature has changed from a first value to a second value. In some embodiments, the difference may refer to and/or include a Change of Value (COV). For example, the data engine 510 may determine that the information has changed (e.g., a COV).

In some embodiments, the data engine 510 may transmit data. For example, the data engine 510 may transmit data to the cloud system 505. In some embodiments, the data engine 510 may transmit data responsive to detection of the difference. In some embodiments, the data engine 510 may transmit data to identify the COV. For example, the data engine 510 may transmit a signal that indicated a detection of a COV, and the signal may provide the new information (e.g., the COV). In other embodiments, a controller (e.g. controller 565) may transmit data directly to the cloud system 505. In some embodiments, the controller 565 may transmit a signal that indicated a detection of a COV, and the signal may provide the new information (e.g., the COV).

As a non-limiting example, the data engine 510 may receive, at a first point in time, a first temperature reading from the sensor 570. To continue this non-limiting example, the first temperature reading may be 72 degrees Fahrenheit. The data engine 510 may store the first temperature reading in the data store 560. To continue this non-limiting example, the data engine 510 may receive, at a second point in time, a second temperature reading. The second temperature reading may be 75 degrees Fahrenheit. To continue this non-limiting example, the data engine 510 may detect, based on a comparison of the first temperature reading and the second temperature reading, a COV (e.g., the temperature has changed). The data engine 510 may transmit data, to the cloud system 505, that identifies the COV.

In some embodiments, the data engine 510 may update the live cache (e.g., the previous information) to reflect the COV. For example, the data that was stored in the data store that pertained to a given piece of information may be updated to reflect the COV. In some embodiments, the data engine 510 may compare subsequent information, received by the elements of the building, based on the information that may be updated to reflect the COV.

In some embodiments, the data engine 510 may detect the COV based on one or more predetermined threshold. For example, the data engine 510 may detect a COV for a room temperature responsive to the difference between values exceeding a given amount. As a non-limiting example, the difference may be 2 degrees Fahrenheit. In this non-limiting example, the data engine 510 may detect a COV when the room temperature changes from 73 degrees Fahrenheit to 76 degrees Fahrenheit. To continue this non-limiting example, the data engine determine that a COV did not occur when a room temperature changes from 72 degrees to 73 degrees.

In some embodiments, the data engine 510 may prevent transmission of data. For example, the data engine 510 may not transmit information to the cloud system 505 responsive to a determination that a COV did not occur. Stated otherwise, the data engine 510 may not transmit signals when differences between information are within a predetermined threshold. In some embodiments, the predetermined thresholds may be based on one or more actions that may be performed by the cloud system 505. For example, a room temperature of 72 degrees Fahrenheit and 73 degrees Fahrenheit may result in the cloud system 505 generating a first control signal. To continue this example, given that a different control signal may not be generated by the cloud system 505 there may not be a benefit to transmit information to the cloud system 505 when the temperature of the room changed by 1 degree.

In some embodiments, the data engine 510 may provide information without a prompt and/or a request for information. For example, the data engine 510 may provide COV information to the cloud system 505 without the cloud system 505 having prompted the data engine 510. Stated otherwise, the data engine 510 may provide information without first being prompted for the information.

In some embodiments, the data engine 510 may receive, from the elements of the building, information in one or more formats. For example, the data engine 510 may receive information in a BACnet format. To continue this example, the data engine 510 may receive value objects from the elements of the building 10. In some embodiments, the elements of the building 10 (e.g., the controller 565, the sensor 570, the equipment 575, and/or the actuator 580) may operate and/or is controllable in the first format. For example, the equipment 575 may be operable and/or controllable by control signals that are in the first format. In some embodiments, the cloud system 505 may be unable to decipher and/or identify information that is in the first format. For example, the cloud system 505 may be unable to identify value points in BACnet.

In some embodiments, the data engine 510 may communicate with at least one component or device of the system 500 via one or more secured and/or credential-based communication. For example, the data engine 510 may communicate with the cloud system 505 via Transport Layer Security (TLS) protocol. As another example, the data engine 510 may communicate with the cloud system 505 via Advanced Message Queuing Protocol (AMQP).

In some embodiments, the data engine 510 may provide one or more prompts. For example, the data engine 510 may provide prompts to the cloud system 505. In some embodiments, the data engine 510 may provide prompts for credentials. For example, the data engine 510 may provide prompt to the cloud system 505 to provide a credential. In some embodiments, the credential may identify a device and/or a component. For example, the credential may verify the cloud system 505. In some embodiments, the cloud system 505 may provide the credential and the data engine 510 may receive the credential.

In some embodiments, the data engine 510 may verify the credential. For example, the data engine 510 may store, in the data store 560, credential information and the data engine may compare the credential, provided by the cloud system 505, with the credential information. In some embodiments, the data engine 510 may verify the cloud system 505 based on a match. For example, the credential provided by the cloud system 505 may match the credential information that is stored in the data store 560. In some embodiments, the data engine 510 may provide COV information with the cloud system 505 responsive to the data engine 510 verifying the cloud system 505.

In some embodiments, one or more processes and/or operations that have been described as being performed by a first system, a first device, and/or a first component may also be performed by a second system, a second device, and/or a second component. For example, operations that have been described as being performed by the cloud system 505 may also be performed by the data engine 510.

In some embodiments, the processing circuit 515 may receive one or more sets of data. For example, the processing circuit 515 may receive data from the data engine 510. In some embodiments, the processing circuit 515 may receive data collected by the sensors 570. The processing circuits 515 may receive data that corresponds to one or more parameters of a building. For example, the processing circuit 515 may receive data that corresponds to temperature values (e.g., parameters) corresponding to at least one of floors, zones, spaces, and/or areas of the building 10. As another example, the processing circuit 515 may receive data that is indicative of light settings (e.g., parameters) corresponding to various floors, zones, spaces, and/or areas of the building 10. As even another example, the processing circuit 515 may receive data that corresponds to server rack temperature (e.g., a temperature of one or more severs racks located in the building 10). To continue this example, the sensors 570 may include temperature sensors that are embedded into the sever racks and/or located proximate to the server racks. In this example, the sensors 570 may collect data to indicate various temperatures of the server racks.

In some embodiments, the processing circuit 515 may receive sets of data that correspond to one or more aspects of a building. For example, the processing circuit 515 may receive sets of data that correspond to aspects of the building 10. In some embodiments, one or more aspects of the building 10 may include at least one of temperature values, temperature ranges, building setpoints, occupancy metrics, lighting metrics, equipment runtime, equipment operational data, and/or various other aspects of the building 10. The one or more aspects of the building 10 may include at least one of zones, regions, floors, rooms, spaces, people, or building statuses. For example, a first aspect of the building 10 may refer to a first room of the building 10 and a second aspect of the building 10 may refer to a second room of the building 10.

In some embodiments, the processing circuit 515 may receive data that includes one or more values. For example, the processing circuit 515 may receive data that includes one or more temperature values (e.g., room temperature, zone temperature, ambient temperature) for the building 10. These values may correspond to an initial set of data collected by the data engine 510 on system startup.

In some embodiments, the processing circuit 515 may generate a graphical representation of the values received from the data engine 510. The graphical representation may be a live value map of one or more temperature values, CO2 values, occupancy values, etc. for the building 10. The values may be individually represented on the graphical representation generated by the processing circuit 515. In exemplary embodiments, the individual values represented on the graphical representation may be selectable by a user. In some embodiments, the graphical representations include selectable elements, such that a user may select a displayed value, included in a user interface, to receive and/or see additional information. The additional information may be individual sensor measurements, such as current temperature value, previous temperature values, CO2 values, occupancy values, etc.

In some embodiments, the processing circuit 515 may receive one or more datasets. For example, the processing circuit 515 may receive COV data (e.g., a dataset) from the data engine 510. The processing circuits 515 may receive COV data that corresponds to the one or more aspects of a building. For example, the processing circuit 515 may receive COV data that corresponds to a change in temperature value (e.g., a COV event affecting a parameter) corresponding to at least one of floors, zones, spaces, and/or areas of the building 10.

In some embodiments, the processing circuit 515 may update the graphical representation. For example, the processing circuit 515 may update the values contained in the graphical representation on an individual basis. As another example, the processing circuit 515 may receive a COV that corresponds to a change in a temperature value in an area of the building 10. To continue this example, the processing circuit 515 may update the graphical representation of the individual temperature value according to the change in temperature value.

In some embodiments, the graphical representation may comprise a heatmap of temperature values. The heatmap may be a map of a room, a corridor, a building, a campus, and/or various other portions or aspects of a building. The temperature values may be displayed according to a corresponding color-coded key. In some embodiments, the heatmap may be included in and/or refer to at least one of the user interfaces described herein. In other embodiments, the graphical representation may comprise a value map of other data values, such as humidity, CO2 levels, occupancy levels, and the like.

In some embodiments, the cloud system 505 may set a predetermined threshold for a COV. In this way, a change of value may not be indicated on the user interface when the change of value is lower than the predetermined threshold. For example, a detected change of temperature that is less than 1° F. may not cause the graphical representation of the corresponding data point displayed on the heatmap to change. In another example, a detected change of temperature is 3° F., which is above the exemplary preset temperature threshold of 1° F. of temperature change, causes the cloud system 505 to update the graphical representation according to the 3° F. COV.

In some embodiments, the processing circuit 515 may receive one or more indications. For example, the processing circuit 515 may receive an indication of a selection of a selectable element. To continue this example, the indication may be an indication that a given icon or button, included in a user interface, has been selected. In some embodiments, the selection and/or the selectable element may be associated with a given aspect of the building 10. For example, a first selectable element may be associated with a room temperature of a given room in the building 10. As another example, the processing circuit 515 may receive an indication of a predetermined range that defines one or more COVs. To continue this example, the processing circuit 515 may receive, from the client device 507, a difference between temperature values that may trigger a detection of a COV. In this example, the predetermined difference may be a difference of 2 degrees Fahrenheit (e.g., increase or decrease of a temperature by 2 degrees). As another example, the processing circuit 515 may receive an indication of a predetermined range from a user device (e.g., the client device 507). To continue this example, the predetermined range may define a difference between one or more values (e.g., a difference that dictates what results in a detection of one or more COVs).

In some embodiments, the processing circuit 515 may update the user interface responsive to receipt of one or more indications. For example, the processing circuit 515 may update a user interface responsive to receipt of an indication that a given selectable element has been selected. In some embodiments, the processing circuit 515 may update the user interface to include information associated with a given aspect of the building 10. For example, a given selection of a selectable element may correspond to a room temperature for a given zone of the building 10. To continue this example, the processing circuit 515 may update the user interface to include additional information that corresponds to the given zone. In some embodiments, the additional information may include zone temperature trends, a max temperature value, a low temperature value, current setpoints, scheduled setpoints, and/or COV events.

In some embodiments, the controllers 565 may communicate directly with the cloud system 505. For example, the controllers 565 may communicate with the cloud system 505 via the network 446. In some embodiments, the controller 565 may directly transmit one or more messages, to the cloud system 505, to indicate one or more COVs. For example, the controller 565 may transmit one or more data packets that indicate the COVs to the cloud system 505.

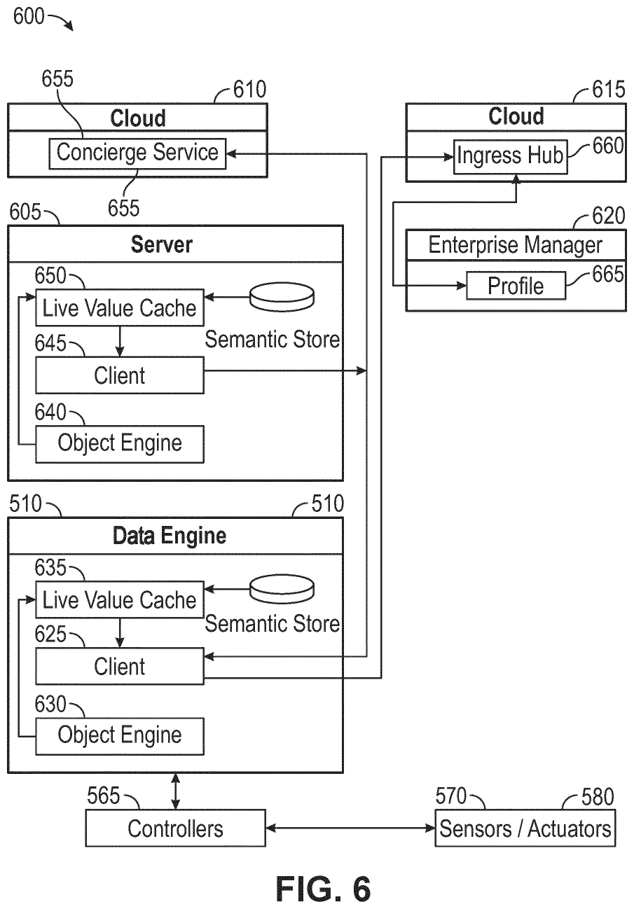

FIG. 6 depicts a flow diagram illustrating communication between one or more components of a system architecture 600, according to some embodiments. In some embodiments, the system architecture 600 may refer to and/or be implemented as the system 500. For example, one or more components of the system 500 may communicate using the system architecture 600. In some embodiments, the system architecture 600 may include at least one system, device, and/or component of the system 500. For example, the system architecture 600 may include the cloud system 505. In some embodiments, at least one system, device, and/or component of the system 500 may perform operations similar to that of the system architecture 600 and/or a component thereof. In some embodiments, systems, devices, and/or components of the system architecture 600 may be added, removed, integrated, combined, separated, rearranged, relocated, and/or replaced. For example, the system architecture 600 may be shown to include a first component and a second component. To continue this example, the system architecture 600 may be modified to have the second component removed from the system architecture 600.

In some embodiments, the system architecture 600 may include one or more systems, devices, and/or components. For example, the system architecture 600 may include sensors, actuators, controllers, engines, servers, and/or cloud servers. In some embodiments, systems, devices, and/or components of the system architecture 600 may include one or more systems, devices, and/or components described herein. For example, sensors and actuators may include the sensors 570 and the actuators 580.

As shown in the FIG. 6, the systems, components, and devices of the system architecture 600 may be in communication with one another. For example, the sensors 570 and actuators 580 are shown to be in communication with the controllers 565. In some embodiments, the controllers 565 may provide control signals to the sensors 570 and actuators 580. For example, the controllers 565 may provide control signals to the actuators 580 to cause the actuators 580 to move a damper. As another example, the controllers 565 may transmit a control signal to the sensors 570 to cause the sensors 570 to capture a room temperature measurement.

The controllers 565 may be in communication with the data engine 510. For example, the controllers 565 may provide equipment information to the data engine 510. In some embodiments, the controllers 565 may provide the various types of information described herein to the data engine 510. For example, the controllers 565 may provide equipment runtime information to the data engine 510.

As shown in FIG. 6, the data engine 510 includes an object engine 630, a client 625, a live value cache 635, and a semantic store. In some embodiments, the object engine 630 may identify one or more pieces of equipment and/or one or more values. For example, the object engine 630 may identify that the controllers 565 provided information pertaining to an HVAC system. As another example, the object engine 630 may identify that the information pertaining to the HVAC system includes operational data. In some embodiments, the object engine 630 may update the live value cache 635 responsive to a detection of one or more COVs.

The client 625 may connect the data engine 510 with a server 605, a cloud 615, and/or a cloud 610. For example, the client 625 may include a network interface. In some embodiments, the live value cache 635 may include at least one of the data stores described herein. For example, the live value cache 635 may include the data store 560. In some embodiments, the live value cache 635 may store information that was provided by the controllers 565. For example, the live value cache 635 may store operational data. In some embodiments, the data engine 510 may detect COVs based on the information stored in the live value cache 635. In some embodiments, the semantic store may include identifying information. For example, the semantic store may store semantic information (e.g., information that describes a piece of equipment and/or equipment data).

As a non-limiting example, the semantic store may include information that may be used by the data engine 510 to identify that a piece of equipment is an AHU and that the AHU produces a given type of data. As another non-limiting example, the semantic store may include information that may be used by the data engine 510 to identify that a given piece of sensor data is a zone temperature (e.g., a temperature of a zone).

In some embodiments, information provided by the data engine 510 may be self-identifiable. For example, the data engine 510 may provide information that directly identifies itself. Stated otherwise information, the data engine 510 may provide data that includes and/or indicates what the information is and/or what the information is providing. As shown in FIG. 6, the server 605 include components similar to that of the data engine 510. In some embodiments, the server 605 and the data engine 510 may be combined. As another example, the data engine 510 may include and/or implement the data engine 510 and the server 605.

In some embodiments, the cloud 610 may be included in and/or implemented with the data engine 510 and/or the server 605. In some embodiments, the cloud 610 may be implemented as the cloud system 505. In some embodiments, the cloud 610 may be implemented as the cloud 615. In some embodiments, the cloud 615 may include one or more portions and given portions may implement at least one of the server 605, the cloud 610, and/or the cloud 615. The cloud 615 may include at least one ingress hub 660. In some embodiments, the ingress hub 660 may map data to one or more sources. In other embodiments, the ingress hub may handle (e.g., respond, answer, reply, etc.) one or more Application Programming Interface (API) calls. In some embodiments, enterprise manager 620 may include one or more entities and/or users (shown as profiles 665). For example, the enterprise manager 620 may include a manager of the building 10. As another example, the enterprise manager 620 may include users that view and/or access the various types of information described herein.

In some embodiments, a set of first values (e.g. the initial values collected by the data engines 510 on startup) is transmitted to the cloud 610 and/or the cloud 615. The first set of values may correspond to information maintained in a first cache stored (e.g. live value cache 635) in memory of a computing device. The computing device may include the data engine 510. The computing device can update the information maintained in the first cache based on a detection of one or more COVs by the object engine 630. The computing device may instruct one or more processors to maintain, in a second cache stored (e.g. live value cache 650) in the one or more memory devices, a plurality of values corresponding to a plurality of building parameters. The building parameters may be temperature, humidity, occupancy carbon dioxide levels, or anything of the like. The computing device may instruct the processors to update, responsive to receipt of the first set of data, the second cache (e.g. live value cache 650) to reflect the one or more first values, and update, responsive to receipt of the dataset, the second cache to reflect the COV for the at least one value of the one or more first values.

In some embodiments, the collection of COV data may originate (e.g., start) with the controllers 565 collecting and/or obtaining various data that pertains to the building 10 (e.g., temperature data, operating data, equipment setpoints, occupancy values, schedules, room configurations, etc.). For example, the controllers 565 may receive temperature data from the sensors 570. In some embodiments, the controller 565 may transmit (e.g., forward) the data to the data engine 510. For example, the controllers 565 may transmit signals according to BACnet protocols. As another example, the controllers 565 may transmit signals according to a request-receive protocol (e.g., Modbus, client/server protocol, etc.). In some embodiments, the data engine 510 may compare the data, transmitted by the controllers 565, with information stored in the live value cache 635. The data engine 510 may update the live value cache 635 responsive to a detection of one or more COVs. The data engine 510 may also transmit the COV, responsive to updating the live value cache 635, to the cloud system 505.

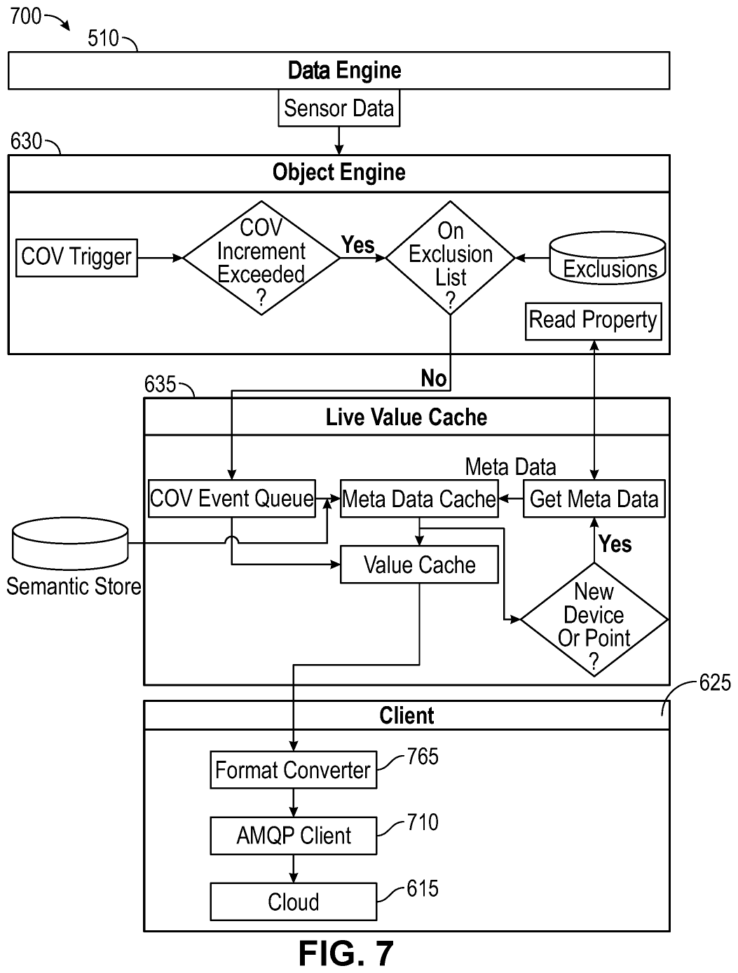

FIG. 7 is a flow diagram of a process 700 for detecting COVs for buildings, according to some embodiments. In some embodiments, at least one step and/or element of the process 700 may be performed by at least one system, device, and/or component of the system 500. For example, the cloud system 505 may perform at least one step of the process 700. In some embodiments, at least one step and/or element of the process 700 may be performed by at least one system, device, and/or component of the system architecture 600.

While several steps and/or elements of the process 700 are described as being performed by systems, devices, and/or components of the system architecture 600, it should be understood that at least one of the various computing systems and/or computing devices described herein may perform at least on step and/or element of the process 700. For example, the data engine 510 may perform at least one of the steps of the process 700.

In some embodiments, the process 700 may include receiving sensor data. For example, the object engine 630 may receive sensor data from the data engine 510. As another example, the object engine 630 may receive sensor data from the controllers 565. In some embodiments, the sensor data may include the various types of data and/or information described herein. For example, the sensor data may include equipment runtime data. As another example, the sensor data may Include building data (e.g., zone temperatures, occupancy information, etc.).

In some embodiments, the process 700 may include detecting a COV trigger. For example, the object engine 630 may determine that the sensor data indicates a COV. As another example, the object engine 630 may compare information stored in the live value cache 635 and the object engine 630 may detect a COV trigger responsive to detecting differences between the sensor data and data stored in the live value cache 635.

In some embodiments, the process 700 may include determining whether a COV increment is exceeded. For example, the object engine 630 may determine that the sensor data indicates a COV, and the object engine 630 may the compare the COV to a predetermined threshold (e.g., an increment). In some embodiments, the sensor data may include zone temperature readings and the object engine 630 may determine that the COV increment is exceeded responsive to a difference between the sensor data and data stored in the live value cache 635 exceeding a given value, amount, temperature, and/or number.

In some embodiments, the process 700 may include determining whether a COV is included in an exclusion list. For example, given sensor data may be excluded from COV events. In some embodiments, sensor data may be excluded from COV events based on an exclusion database. For example, a database may include and/or identify sensor data that is excluded from COV events, and the object engine 630 may determine that the COV is included in the exclusion list. In some embodiments, the object engine 630 may determine that the COV is not included in the exclusion list (e.g., the sensor data is absent from the exclusion database).

In some embodiments, the process 700 may include providing a COV to a COV event queue. For example, as COVs are detected by the object engine 630, the object engine 630 may create and/or add COVs to a queue and/or list. In some embodiments, the COVs may be processed continuously and/or semi-continuously. For example, the object engine 630 may detect a COV, and the object engine 630 may then add the COV to an event queue.

In some embodiments, the process 700 may include providing data to a metadata cache. For example, the sensor data may include information that identifies and/or includes metadata and the object engine 630 may add the metadata to the metadata cache. For example, a get metadata call may be performed to retrieve information from a read property. In some embodiments, the metadata may include semantic information and/or identifying information. For example, the metadata may include information that identifies a piece of building equipment as an AHU.

In some embodiments, the process 700 may include providing data to a value cache. For example, portions of the sensor data that include the temperature reading (e.g., a temperature of a room) may be added to the value cache. In some embodiments, the data provided to the value cache may be used to determine subsequent COVs. In some embodiments, the data may be provided to the value cache from the metadata cache.

In some embodiments, the process 700 may include determining that a new device and/or point has been detected. For example, the sensor data may include and/or indicate that a piece of building equipment has been added to the system and/or that a new piece of information has been added to system. In some embodiments, a COV event may include adding equipment to a building site. For example, when an HVAC system is replaced a COV event may occur that indicates new pieces of building equipment. In some embodiments, pieces of equipment may provide and/or produce information that may be new (e.g., provided for a first time). For example, when a new type of light fixture is installed that may result in a new type of setpoint data being provided). In some embodiments, information pertaining to the new pieces of equipment and/or the new information may trigger a subsequent call to the get metadata. In some embodiments, the call to the get metadata may return the various identifying information described herein. For example, the call to the get metadata may return semantic information.

In some embodiments, the process 700 may include converting data. For example, the sensor data may be in a first format that is readable and/or understandable by the object engine 630 and the sensor data may be converted from the first format to a second format. As shown in FIG. 7, the client 625 includes a format converter 765. In some embodiments, the format converter 765 may convert the sensor data from a first format to a second format. In some embodiments, the format converter 765 may convert the sensor data by performing at least one of the various techniques described herein.

In some embodiments, the process 700 may include providing data to a client. For example, the sensor data and/or the COV event, and/or the COV data may be provided to a manager. In some embodiments, the data may be provided to a computing system and/or processing system. For example, the data may be provided to a fault detection system. In some embodiments, the process 700 may include providing the COV event and/or COV data to an AMQP client 710. The AMQP client 710 may provide, responsive to receipt of the COV event and/or COV data, the COV event and/or the COV data to the cloud 615.

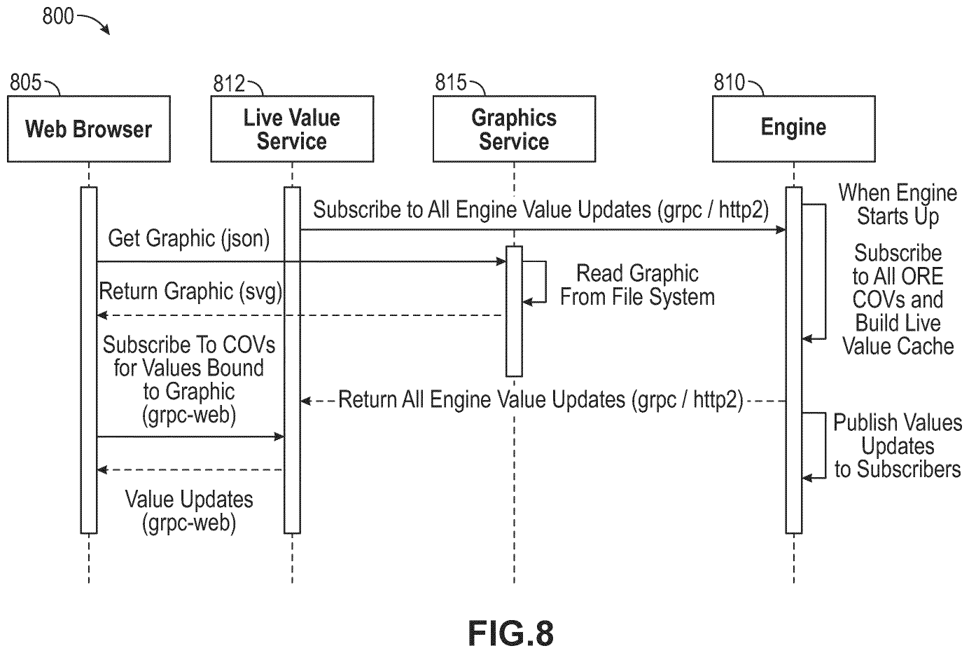

FIG. 8 depicts a sequence diagram of a process 800 for updating a graphic on a user interface, according to exemplary embodiments. The process 800 may include a live value service 812 subscribing to value updates for an engine 810. The live value service 812 may be included in the live value cache 635. The engine 810 may be an edge device connected to the network 446. The engine 810 may publish the data when the engine 810 first starts up and publish COVs when COV events are detected. The engine 810 may return all initial/startup engine values to the live value service 812. As COV events are detected, the engine 810 may return the change of value updates to the live value service 812. A web browser 805 may send a request to get a graphic from a graphics service 815. The request may be a JavaScript Object Notation (JSON) request. The graphics service 815 may return a graphic. For example, the graphics service 815 may generate a graphic and then return the graphic to the web browser 805. As another example, the graphics service 815 may generate a graphic based on values transmitted by the engine 810 to the live value service 812. The returned graphic may be a Scalable Vector Graphics (SVG).

In some embodiments, each local engine (e.g. data engine 510, engine 810, etc.) may create the live value cache 635 of a first set of data. The first set of data may correspond to current values on startup (e.g. initial values or initial measurements). The live value service 812 (e.g. on the live value cache 635, Cloud System 505, etc.) may subscribe to one or more live value caches 635 associated with one or more engines (e.g., data engine 510, engine 810). The live value service 812 may receive, based on one or more subscriptions, a copy of a local engine's startup value data and/or the changes of values. In this way, the live value service 812 may store initial values that correspond to a startup of the data engine 510 and may receive data that corresponds to changes in the initial values (e.g., COVs). The initial values may include one or more subsets, portions, percentages, or segments. For example, the initial values may include one or more combinations of data types. As another example, the initial values may include values and/or value types such as, time value, float value, and/or Boolean value.

In some embodiments, the engines 810 may transmit COVs when data changes in the engines 810. For example, the engines 810 may transmit a COV that is indicative of a temperature change in a given room of the building 10. The engines 810 may publish the COVs to the live value services 812 that have one or more subscriptions.

In some embodiments, the live value cache 635 may serve as a central database that collects all values collected by local data engines. In such an example embodiment, the live value cache 635 may determine changes in values and directly transmit the updated changes in values to a user interface (e.g. a web browser). Whether the COVs are determined at the local level or by the live value service 812, the COVs may be transmitted using binary messaging (e.g. protocol buffer message). Advantageously, binary messages are smaller and faster to encode and decode than traditional JSON, XML, and BACnet encoded messages. The messages may be transmitted via the network 446 according to HTTP/2 protocol. All, one, or any combination of these steps may occur on startup.

After startup of the engines 810, a user may, on a web browser (i.e. a user device, web browser 805, the server 605), enter an input to get a graphic (e.g. a live value heatmap). Responsive to the user input, a request may be sent to the graphics service 815. The graphics service 815 may read a graphic from a file system. The live value service 812 may store and/or maintain the file system.

The graphics service 815 (e.g. the processing circuit 515) may generate a graphic of the initial values collected by the engines (e.g., the data engine 510, engine 810) on startup, according to the transmitted user request. The graphics service 815 may then return the generated graphic to the web browser 805 in the form of a scalable vector graphic (SVG). The graphics service 815 may request initial values gathered by local data engines and/or COVs in data collected by local data engines from the live value cache 635 (e.g. the live value service 812). The graphics service 815 may generate and transmit a graphic (e.g. Scalable Vector Graphic) to the web browser according to the initial data and/or COVs of all or any combination of the engines 810.

For example, a user may operate a user device to view a heatmap. The user may be presented with options to view the heatmap for a room, building zone, whole building, or whole campus. In some embodiments, the graphics service 815 may generate a heatmap responsive to a selection of an icon to view the heatmap. In some embodiments, the heatmap may include initial and any additional value updates from the live value service 812 according to a color key. For example, a local engine that detects an initial/startup temperature value of 99° F. may be displayed in red, while a local engine that detects an initial/startup temperature value of 70° F. may be displayed in green. Since the live value cache 635 and/or the live value service 812 collects initial data and COVs from local engines, rather than collecting data in set intervals (e.g. every minute, every 15 minutes, hourly, etc.) the data used by the graphics service 815 may be transmitted in much smaller messages. Advantageously, this allows the graphics service 815 to render graphics more quickly. This also allows the rendered graphic to be returned to a user after input and request more quickly.

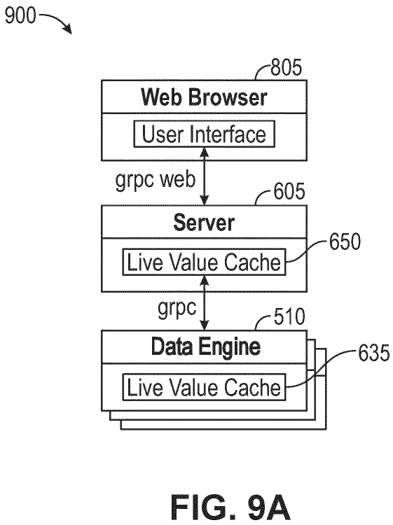

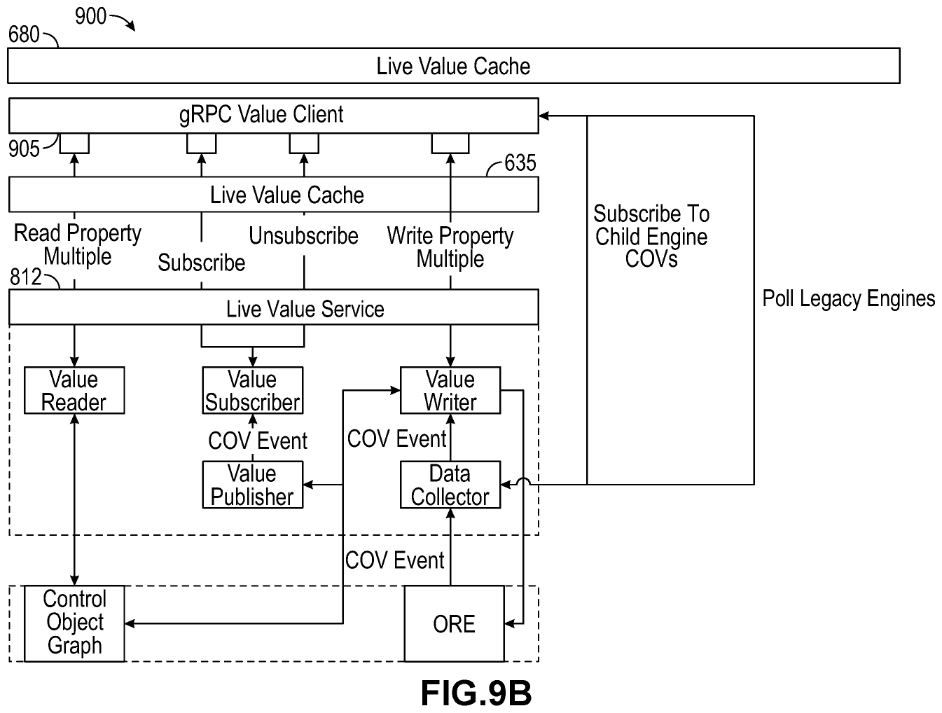

FIG. 9A is a block diagram illustrating communications between components of a system architecture 900. The data engine 510 can include the live value cache 635. In some embodiments, the live value cache 635 may include data collected by the data engine 510. The data engine 510 may determine COV events based on the data collected and stored in the live value cache 635. The data engine 510 may transmit data and/or datasets to the server 605. The datasets may include initial values measured on startup, COV events, all of the data collected during a certain time interval. In some embodiments, the server 605 may detect COV events by comparing the values contained in the datasets transmitted from the data engine 510. In other embodiments, the server 605 receives COVs from the data engine 510 and determines whether the COV meets a predetermined threshold. The server 605 may include the graphics service 815 and the live value service 812. The server 605 may also include the live value cache 650. The server 605 may transmit data, graphical representations of data, and/or data trend reports to the web browser 805.

FIG. 9B is a block diagram illustrating communications between one or more components of the system architecture 900. In some embodiments, the system architecture 900 and/or one or more components thereof may detect COVs for buildings. For example, the system architecture 900 may detect COVs for the building 10. In some embodiments, at least one system, components, and/or device of the system 500 may be included in or represented by the system architecture 900. For example, the cloud system 505 may be included in the system architecture 900.

While communication between one or more components of the system architecture 900 are described with respect to systems, devices, and/or components of the system architecture 600, it should be understood that at least one of the various computing systems and/or computing devices described herein may be included in the system architecture 900. For example, the data engine 510 may be included in the system architecture 900.

In some embodiments, one or more components of the system architecture 900 may detect a COV trigger. For example, the object engine 630 may determine that the temperature sensor data indicates a COV. As another example, the object engine 630 may compare the stored temperature measurements in a live value cache 635 and the object engine 630 may detect a COV trigger responsive to detecting differences between the sensor data and data stored in the live value cache 635.

In some embodiments, the system architecture 900 includes an ORE (e.g., data engine 510, engine 810, etc.). The ORE may determine whether a COV increment is exceeded. For example, the object engine 630 (e.g. the ORE) may determine that the sensor data indicates a COV. The ORE may send a determined COV event to a data collector (e.g. data store 535). The ORE may compare the COV to a predetermined threshold (e.g., an increment). In some embodiments, the sensor data may include zone temperature readings and the object engine 630 may determine that the COV increment is exceeded responsive to a difference between the sensor data and data stored in the live value cache 635 exceeding a given value, amount, temperature, and/or number. In this way, the ORE may send the COV to a data collector after determining that the COV exceeds a preset increment.

In some embodiments, the system architecture 900 includes a data collector that transmits data to a value cache. For example, portions of the sensor data that include the temperature reading (e.g., a temperature of a room) may be added to the value cache. In some embodiments, the data provided to the value cache by the data collector may be used to determine subsequent COVs. In some embodiments, the data may be provided to the live value cache 635 from the live value service 812. The COVs may be sent to the server by the ORE using gRPC (Remote Procedure Calls) protocols. In this way, the server (e.g. network 446) may transmit the changes in values to a cloud system (e.g. web browser/user interface). Changes in values may then be bound to a graphic generation. For example, a change in temperature may result in a change in presentation on a user accessible heatmap.

In some embodiments, the system architecture 900 may receive one or more types of data having various values. The value reader may receive one type of data, or any combination of data, for example any or all of the types of data types described herein. The live value service 812 may be the live value cache 635 and/or the server 605. For example, the live value service 812 may receive sensor data from the Metasys engine. As another example, the data engine 510 may receive sensor data from the controllers 565. In some embodiments, the sensor data may include the various types of data and/or information described herein. For example, the sensor data may include temperature measurements. On startup, the live value service 812 may subscribe (e.g. the value subscriber) to all startup values and ORE COVs to build a live value cache 635. The value publisher may transmit COV events collected by the data collector from the ORE to the value subscriber. In this way the live value service 812 may contain all or some of the initial values on startup as well as any changes in values (COV events). As shown in FIG. 9B, the data collector is in communication with a gRPC value client 905 (e.g., client 625, client 645, etc.). In some embodiments, the gRPC client 905 may subscribed to one or more COV events for various engines (e.g., data engine 510, engine 810, ORE, etc.). In other embodiments, the gRPC client 905 may also query and/or poll the data collector for information.

In some embodiments, the ORE may convert data from one format to a different format. For example, the sensor data may be in a first format that is readable and/or understandable by the object engine 630 and the sensor data may be converted from the first format to a second format. As another example, the sensor data may be converted based on information included in the semantic store. To continue this example, the semantic store may include format translations and the sensor data may be converted based on the format translations.

In some embodiments, the system architecture 900 includes a server that provides data to a client. For example, the sensor data and/or the COV event, and/or the COV data may be provided to a manager. This data may be transmitted from the live value cache 635 via the server to a web browser that is user accessible. The data may first be transmitted to the graphics service 815 to generate a graphical representation of the sensor data and/or the COV event (e.g. a heatmap, a CO2 map, an occupancy map, etc.). In alternate embodiments, the raw data may be transmitted directly to the user accessible web browser. The live value cache 635 may continue to update the transmitted graphical representations and/or raw data as COV events are detected.

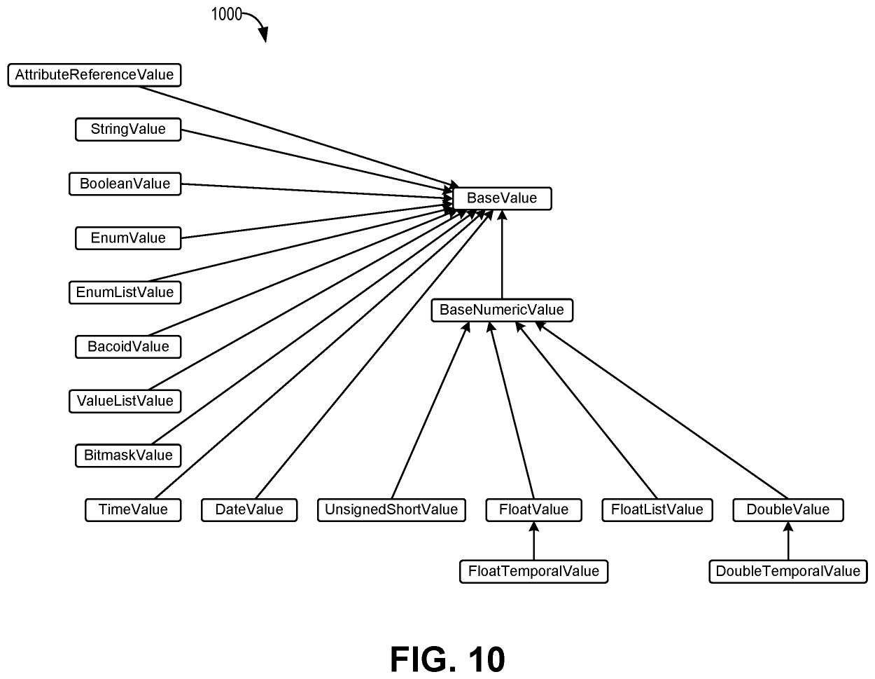

Referring to FIG. 10, a schematic diagram of a data model 1000, according to an exemplary embodiment. In some embodiments, the data model 1000 can be a polymorphic data model. The data model 1000 (i.e. the polymorphic data model) may describe many of the types of complex data that may be returned to a live value cache 635 from a building automation system. This polymorphic data model may be hierarchical in nature, which allows the building automation system to transmit one or more portions and/or one or more segments of the collected data by abiding to a hierarchical data transmission method. As shown in FIG. 10, the data may be numeric values (e.g. unsigned short values, float values, float list values, double values, etc.) The data may also or alternatively be non-numeric values (e.g. attribute reference values, string values, Boolean values, enum/enum list values, bacoid values, value list values, bitmask values, time values, etc.).

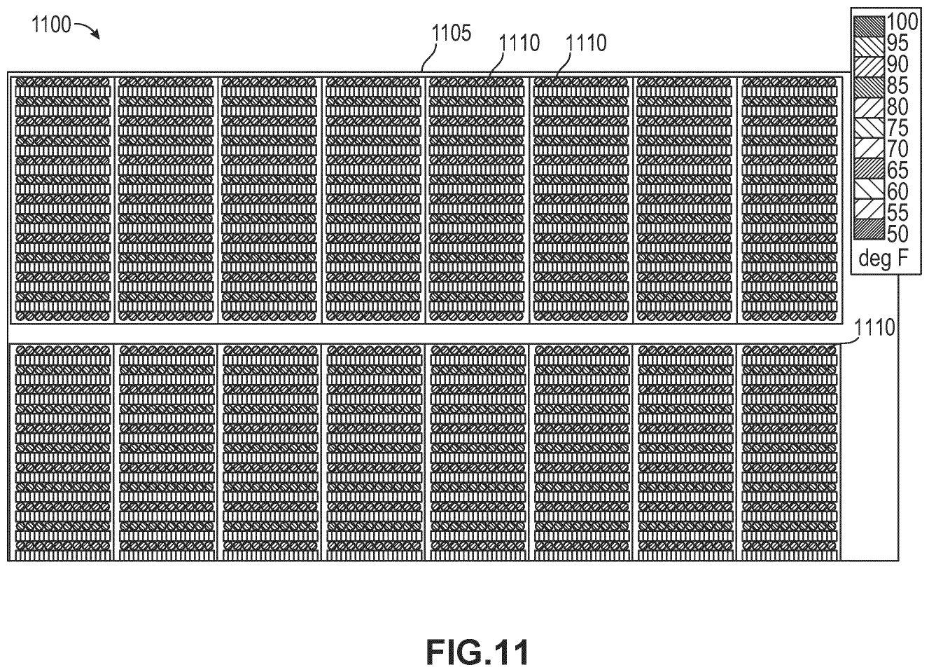

FIG. 11 depicts a user interface 1100 including a graphical representation of data, according to an exemplary embodiment. In some embodiments, the user interface 1100 may be displayed by one or more devices. For example, the client device 507 may display the user interface 1100. In some embodiments, the user interface 1100 may include one or more graphical representations. For example, the user interface 1100 may include icons, toggles, pictures, and/or buttons. In some embodiments, the user interface 1100 may include at least one heatmap 1105. The heatmap 1105 may include temperature data on a room-by-room basis, a building wide basis, and/or a campus wide basis. In some embodiments, the heatmap 1105 may refer to and/or include at least one of the heatmaps described herein. The heatmap 1105 may provide visual depictions of various building information. For example, the heatmap 1105 may represent room temperatures based on temperature information collected by the sensors 570.

In some embodiments, the user interface 1100 may include at least one dot 1110 or element 1110 that represent various information. For example, the dots 1110 may represent and/or indicate room temperatures for one or more rooms of the building 10. As another example, the dots 1110 may represent humidity in various zone of the building 10. In some embodiments, the dots 1110 may be presented or displayed based on a key, such as a color-coded key. In some embodiments, the heatmap 1105 and/or the elements 1110 may be updated based on COV datasets. For example, a first element 1110 may be updated from a first color to a second color based on information included in a COV dataset. In some embodiments, high temperatures (e.g. temperatures greater than 90° F.) may be displayed on the heatmap in red. In other embodiments, high temperatures may be displayed in a different color or shape. In some embodiments, the placement and/or location of the elements 1110, within the heatmap 1105, may be indicative and/or represent a given location (e.g., room, zone, floor, space, campus, etc.) within the building 10. For example, elements 1110 within a given row of the heatmap 1105 may represent given rooms and the given rooms may be located in a given floor of the building 10. As another example, the elements 1110 may represent and/or indicate placement of the sensors 570 within the building 10.

In some embodiments, the heatmap 1105 may represent temperature data for one or more servers of a server rack. For example, a first element 1110 may represent a temperature of a first sever and a second element 1110 may represent a temperature of a second server. To continue this example, the heatmap 1105 may be generated based on location information (e.g., x and y coordinates, latitude, longitude, etc.) of the sensors 570. Stated otherwise, the sensors 570 may know their location, in space, and the heatmap 1105 may be generated based on the known locations of the sensors 570.

In some embodiments, the graphics service 815 may generate the heatmap 1105. For example, the graphics service 815 may generate the heatmap 1105 responsive to a request from a user device (e.g. on a web browser). As another example, the graphics service 815 may automatically generate and transmit graphical representations of sensor values (e.g. heatmaps) to a web browser. In some embodiments, the graphics service 815 may automatically update one or more graphical display points (e.g., the elements 1110) based on a detection of a COV event. For example, the graphics service 815 may update the heatmap 1105 responsive to a change in the live value cache 635.

As another example, the heatmap 1105 may have a given element 1110 that includes a green dot based on an initial measured temperature value of 70° F. To continue this example, graphics service 815 may update the given element 1110 (from green to yellow) based on a COV event that indicates a measured temperature value of 80° F. In this example, the graphics service 815 may update the given element 1110 based on a change in the live value cache 635.

In some embodiments, the initial data transmitted to the live value cache 635 on startup may include every data point measured by the sensors 570. For example, the graphics service 815 may generate the heatmap 1105 based on the initial data (e.g., the startup data) collected by the data engine 510. In some embodiments, the startup data may be a substantial file size. For example, the startup data may be in excess of 150 kilobytes (KB). As another example, the startup data may include various numbers of bytes such as 10, KB, 50 KB, and/or 1 Mb. Conversely, the COV data may be less than 40 bytes, according to some examples.

In some embodiments, transmission of COV data may reduce the amount of data that is transferred to update and/or adjust the heatmap 1105. For example, the COV data may be transmitted as a 2 bytes value and the COV data (e.g., the 2 bytes value) may be included with a Guid identifier that is 16 bytes. In this example, the COV data may be transmitted in as little as 18 bytes (e.g., 16 bytes and 2 bytes). As another example, COV data may be transmitted via 38 bytes according to endianness of the Guid identifier. In either of these examples, the transmission of the COV data substantially reduces the size of data that is used to update the heatmap 1105. Additionally, the reduction in the size of the COV data, relative to the initial data, decreases the amount of time to update the heatmap 1105.

While some examples described herein have described the user interface 1100 as including the heatmap 1105, the graphical representations included in the user interface 1100 may also include representations of various building data, such as CO2 detection, occupancy rates, humidity data, lighting settings, building setpoints, equipment statues, fault detection information, pressure data, network sensor data, and/or other possible types of information.

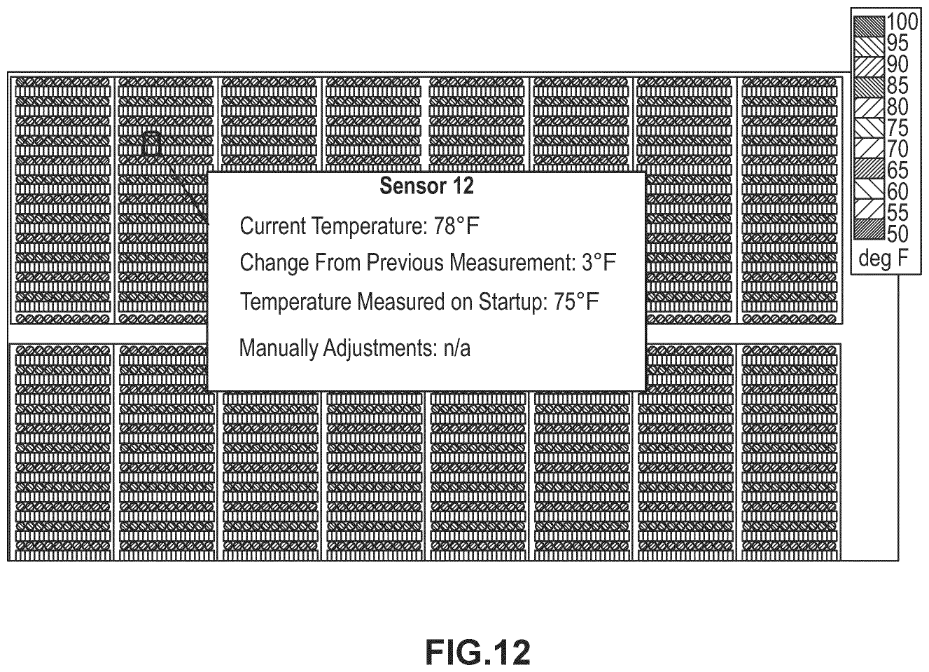

FIG. 12 depicts an overlay that may be displayed over the user interface 1100, according to an exemplary embodiment. In some embodiments, a user may select, interface with, and/or otherwise interact with the elements 1110. For example, a user may select at least one element 1110. In some embodiments, the cloud system 505 and/or the graphics service 815 may generate an overlay responsive to the selection of the element 1110. In some embodiments, the overlay may include additional information that pertains to the element 1110. For example, the overlay may indicate a given location within the building (e.g., a room, a zone, a floor, etc.). As another example, the element 1110 may represent a given server within a server rack. To continue this example, the overlay may indicate and/or identify the given server. As even another example, the overlay may include numerical data, such as current value, historical values, value on startup, or user provided information. In some embodiments, a user may manually adjust various values included in the overlay and/or the elements 1110.

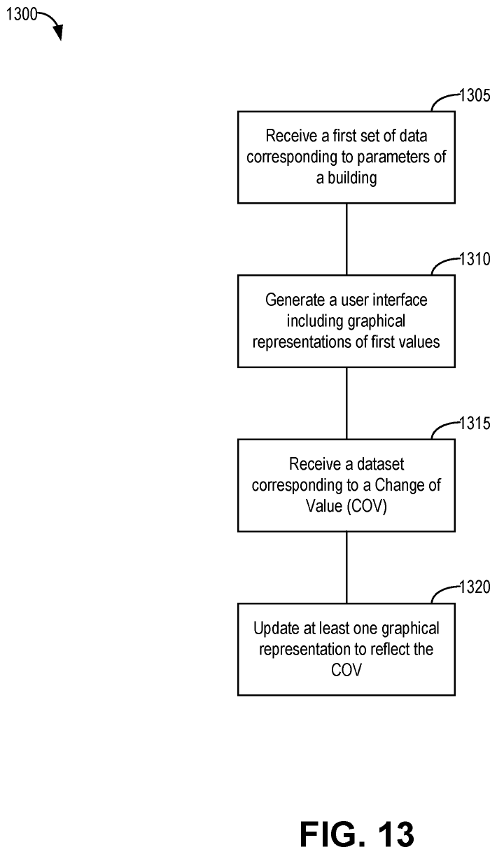

FIG. 13 depicts a flow diagram of a process 1300 to detect one or more COVs, according to some embodiments. In some embodiments, the process 1300 and/or one or more steps thereof may be performed and/or executed by at least one of the various systems, devices, and/or components described herein. For example, the data engine 510 may perform at least one step of the process 1300. As another example, the cloud system 505 may perform at least one step of the process 1300.

In some embodiments, at step 1305, a first set of data may be received. For example, the data engine 510 may receive the first set of data from the controllers 565. As another example, the cloud system 505 may receive the first set of data from the data engine 510. In some embodiments, the first set of data may include the startup data described herein. For example, the first set of data may include initial data collected by the data engine 510. In some embodiments, the first set of data may correspond to one or more parameters of a building. For example, the first set of data may include temperature data for one or more rooms of a building (e.g., one or more aspects). In some embodiments, the first set of data may include one or more values. For example, the first set of data may include initial room temperatures for the building 10. As another example, the first set of data may include a number of occupants within given zones of the building 10.

In some embodiments, the cloud system 505 may receive the first set of data based on one or more subscriptions. For example, the cloud system 505 may be enrolled in a subscription to receive data from a given data engine 510. To continue this example, the given data engine 510 may transmit, based on the subscription, the first set of data. In some embodiments, the sensors 570 may collect and/or otherwise obtain the first set of data. For example, the sensors 570 may collect temperature data and the first set of data may include the temperature data. As another example, the sensors 570 may collect various types of data the corresponds to the building such as, humidity, occupancy, CO2 level, etc.).

In some embodiments, at step 1310, a user interface may be generated. For example, the graphics service 815 may generate a user interface based on the first set of data received in step 1305. As another example, the graphics service 815 may generate a user interface based on data stored in the live value cache 650. In some embodiments, one or more devices may display and/or present the user interface 1100. For example, the client device 507 may display the user interface 1100. As another example, the web browser 805 may display the user interface 1100.

In some embodiments, the user interface 1100 may include one or more graphical representations. For example, the user interface 1100 may include the elements 1110. In some embodiments, the elements 1110 may represent and/or indicate the values included in the first set of data. For example, a first element 1110 may represent a temperature (e.g., a value) of a first room and a second element 1110 may represent a temperature (e.g., a value) of a second room. In some embodiments, the graphical representations may include selectable elements. For example, the elements 1110 may include buttons, toggles, check boxes, and/or icons.

In some embodiments, at step 1315, a dataset may be received. For example, the cloud system 505 may receive the dataset. In some embodiments, the cloud system 505 may receive the dataset based on one or more COV events. For example, the cloud system 505 may receive the dataset responsive to the data engine 510 detecting a COV event. As another example, the cloud system 505 may receive the dataset based on an update to the information stored in the live value cache 635. In some embodiments, the dataset may correspond to a COV event for at least one value. For example, the dataset may correspond to a COV event for a temperature value that was included in the first set of data. As another example, the dataset may correspond to a COV event regarding a change in occupancy for a room in the building.

In some embodiments, at step 1320, the user interface may be updated. For example, the graphics services 815 may update the user interface generated in step 1310. As another example, the graphics services 815 may update the user interface 1100. In some embodiments, the graphics service 815 may update at least one graphical representation included in the user interface. For example, the graphics service 815 may update a given element 1110 to change the given element 1110 from a first color to a second color. As another example, the graphics service 815 may update the given element 1110 to change the given element 1110 from a first shape to a second shape. In some embodiments, the graphics services 815 may update the graphical representations to reflect one or more COVs. For example, the graphics service 815 may update the graphical representations to reflect a new temperature value for a given floor of the building.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied and the nature or number of discrete elements or positions can be altered or varied. Accordingly, all such modifications are intended to be included within the scope of the present disclosure. The order or sequence of any process or method steps can be varied or re-sequenced according to alternative embodiments. Other substitutions, modifications, changes, and omissions can be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure can be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general-purpose computer, special purpose computer, or special purpose processing machines to perform a certain function or group of functions.

Although the figures show a specific order of method steps, the order of the steps may differ from what is depicted. Also, two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps and decision steps.

What is claimed is:

1. A Building Management System (BMS) comprising one or more memory devices storing instructions thereon that, when executed by one or more processors, cause the one or more processors to:
receive a first set of data corresponding to a plurality of parameters of one or more aspects of a building, the first set of data including one or more first values;
generate, responsive to receipt of the first set of data, a user interface including one or more graphical representations of the one or more first values, the one or more graphical representations including selectable elements;
receive, from a computing device in communication with one or more pieces of building equipment of the building, a dataset corresponding to a Change of Value (COV) for at least one value of the one or more first values; and
update, responsive to receipt of the dataset, at least one graphical representation of the one or more graphical representations to reflect the COV for the at least one value of the one or more first values.

2. The BMS of claim 1, wherein the one or more first values correspond to information maintained in a first cache stored in memory of the computing device, wherein the computing device is configured to update the information maintained in the first cache based on a detection of one or more COVs, and wherein the instructions cause the one or more processors to:
maintain, in a second cache stored in the one or more memory devices, a plurality of values corresponding to the plurality of parameters, the plurality of values provided by the computing device;
update, responsive to receipt of the first set of data, the second cache to reflect the one or more first values; and
update, responsive to receipt of the dataset, the second cache to reflect the COV for the at least one value of the one or more first values.

3. The BMS of claim 1, wherein the instructions cause the one or more processors to:
receive, responsive to updating the at least one graphical representation of the one or more graphical representations, an indication of a selection of at least one selectable element of the selectable elements, the at least one selectable element associated with a given aspect of the one or more aspects of the building; and
update, responsive to receipt of the indication, the user interface to include information associated with the given aspect of the one or more aspects of the building.

4. The BMS of claim 1, wherein the one or more graphical representations of the one or more aspects of the building include a heatmap of the building.

5. The BMS of claim 1, wherein the computing device is configured to determine the COV based on:
a difference between the one or more first values and one or more second values stored in a cache of the computing device, and wherein the computing device is configured to communicate one or more subsequent COVs.

6. The BMS of claim 1, wherein the instructions cause the one or more processors to:
receive, from a user device, an indication of a predetermined range to define a difference between the one or more first values and one or more second values; and
provide, via a connection with the computing device, the indication of the predetermined range to cause the computing device to detect subsequent COVs based on given values that exceed the predetermined range.

7. The BMS of claim 1, comprising:
the first set of data comprising a first size;
the dataset comprising a second size; and
the second size less than the first size.

8. The BMS of claim 1, comprising:
the first set of data comprising a first number of bits; and
the dataset comprising a second number of bits less than the first number of bits.

9. The BMS of claim 1, wherein the computing device is an edge device located at the building, and wherein at least a portion of the BMS is stored via a server bank remote to the building.

10. A method, comprising:
receiving, by one or more processing circuits, a first set of data corresponding to a plurality of parameters of one or more aspects of a building, the first set of data including one or more first values;
generating, by the one or more processing circuits, responsive to receipt of the first set of data, a user interface including one or more graphical representations of the one or more first values, the one or more graphical representations including selectable elements;
receiving, by the one or more processing circuits from a computing device in communication with one or more pieces of building equipment of the building, a dataset corresponding to a Change of Value (COV) for at least one value of the one or more first values; and
updating, by the one or more processing circuits responsive to receipt of the dataset, at least one graphical representation of the one or more graphical representations to reflect the COV for the at least one value of the one or more first values.

11. The method of claim 10, wherein the one or more first values correspond to information maintained in a first cache stored in memory of the computing device, wherein the computing device is configured to update the information maintained in the first cache based on a detection of one or more COVs, and comprising:
maintaining, by the one or more processing circuits in a second cache stored in one or more memory devices, a plurality of values corresponding to the plurality of parameters, the plurality of values provided by the computing device;
updating, by the one or more processing circuits responsive to receipt of the first set of data, the second cache to reflect the one or more first values; and
updating, by the one or more processing circuits responsive to receipt of the dataset, the second cache to reflect the COV for the at least one value of the one or more first values.

12. The method of claim 10, comprising:
receiving, by the one or more processing circuits responsive to updating the at least one graphical representation of the one or more graphical representations, an indication of a selection of at least one selectable element of the selectable elements, the at least one selectable element associated with a given aspect of the one or more aspects of the building; and
updating, by the one or more processing circuits responsive to receipt of the indication, the user interface to include information associated with the given aspect of the one or more aspects of the building.

13. The method of claim 10, wherein the one or more graphical representations of the one or more aspects of the building include a heatmap of the building.

14. The method of claim 10, wherein the computing device is configured to determine the COV based on:
a difference between the one or more first values and one or more second values stored in a cache of the computing device, and wherein the computing device is configured to communicate one or more subsequent COVs.

15. The method of claim 10, comprising:
receiving, by the one or more processing circuits from a user device, an indication of a predetermined range to define a difference between the one or more first values and one or more second values, wherein detection of a given value that exceeds the predetermined range causes the computing device to detect a subsequent COV.

16. The method of claim 10, comprising:
the first set of data comprising a first size;
the dataset comprising a second size; and
the second size less than the first size.

17. The method of claim 10, comprising:
the first set of data comprising a first number of bits; and
the dataset comprising a second number of bits less than the first number of bits.

18. The method of claim 10, wherein the computing device is an edge device located at the building, and wherein the one or more processing circuits are stored in a server bank remote to the building.

19. A Building Management System (BMS) comprising one or more memory devices storing instructions thereon that, when executed by one or more processors, cause the one or more processors to:
establish a connection with an edge device to communicate with the edge device, the edge device configured to maintain a first cache stored in memory of the edge device, the first cache including a first set of data corresponding to a plurality of parameters of one or more aspects of a building, and the first set of data including one or more first values;
receive, via the connection from the edge device, the first set of data;
update, responsive to receipt of the first set of data, a second cache to reflect the one or more first values, the second cache stored in the one or more memory devices;
generate, based at least one the update to the second cache, a user interface including one or more graphical representations of the one or more first values, the one or more graphical representations including selectable elements;
receive, via the connection from the edge device, a dataset corresponding to a Change of Value (COV) for at least one value of the one or more first values;
update, responsive to receipt of the dataset, the second cache to reflect the COV for the at least one value of the one or more first values; and
update, responsive to receipt of the dataset, at least one graphical representation of the one or more graphical representations to reflect the COV for the at least one value of the one or more first values.

20. The BMS of claim 19, wherein the first set of data includes a first size, and wherein the dataset includes a second size less than the first size.
